(19) United States
(12) Patent Application Publication
(10) Pub. No.: US 2019/0200664 A1
(43) Pub. Date: Jul. 4, 2019

(54) WATER AND FAT SOLUBLE MICRONUTIENT STABILIZED PARTICLES

(71) Applicant: Massachusetts Institute of Technology, Cambridge, MA (US)

(72) Inventors: Aaron Anselmo, Cambridge, MA (US); Xian Xu, Plainsboro, NJ (US); Wen Tang, Everett, MA (US); Robert S. Langer, Newton, MA (US); Ana Jaklenec, Lexington, MA (US)

(21) Appl. No.: 16/239,284

(22) Filed: Jan. 3, 2019

Related U.S. Application Data
(60) Provisional application No. 62/613,485, filed on Jan. 4, 2018.

(51) Int. Cl. A23P 10/30; A23P 10/40; A23L 33/16; A23L 33/155; A23P 20/10; A23K 40/30; A23K 40/10; A23K 20/20; A23K 20/174

(52) U.S. Cl. CPC A23P 10/30; A23P 10/40; A23L 33/16; A23L 33/155; A23V 2002/00; A23K 40/30; A23K 40/10; A23K 20/30; A23K 20/174; A23P 20/10

(57) ABSTRACT

Particulate formulations containing one or more micronutrients such as iron supplements such as ferrous sulfate, fat or oil soluble vitamins such as vitamin A, D, and E, water soluble vitamins such as B vitamin family, and other micronutrients have been developed. These formulations resist oxidation and loss of bioactivity during processing, storage and cooking. The particles include one or more enteric polymers such as pH-sensitive polymers. To prevent oxidation, the iron supplements are encapsulated by a polymer such as hyaluronic acid (“HA”), preferably in a ratio of iron:HA of between 1:4 and 1:10), or mixed with a compound such as vitamin C. The resulting mixture is then dispersed in a solution of a enteric polymer, and manufactured using techniques such as spray drying or spinning disc atomization into particles into particles.

### CROSS-REFERENCE TO RELATED APPLICATIONS

This application claims benefit of U.S. Provisional Application No. 62/613,485 “STABLE VITAMIN A AND IRON SUPPLEMENTAL PARTICLES”, filed Jan. 4, 2018 by Aaron Anselmo, Xian Xu, Wen Tang, Robert S. Langer and Ana Jaklenec, hereby incorporated herein by reference in its entirety.

### FIELD OF THE INVENTION

This invention is in the field of thermally stable particulate micronutrient formulations, particularly related to spray dried vitamin and iron particulate micronutrient formulations.

### BACKGROUND OF THE INVENTION

Malnutrition/micronutrient (MN) deficiency is a severe problem in the developing world, impacting nearly two billion people and causing up to two million child deaths each year. In the developing world, MN deficiency is linked to a variety of illnesses and disabilities in individuals, which in turn dramatically impacts a region's collective socioeconomic development.

Attempts to address micronutrient deficiency include supplementation and fortifications. Supplementation can provide higher doses of micronutrients to specific individuals in a short amount of time. However, supplementation has limitations, including inability to deliver all of the necessary micronutrients, neglecting individuals in non-targeted groups, and low compliance due to the difficulty in storing product under uncontrolled conditions (hot wet warehouses, poor record keeping), difficulties in distributing supplements and convincing end users of the need for regular ingestion.

To address MN-deficiencies, home fortification approaches using MN powders and lipid-based nutrient supplements (LNS) formulated to include up to 22 MNs have been used to target children 6 to 24 months of age. Numerous studies have shown that home fortification programs can be an effective intervention approach to improving MN status and reducing anemia.

However, widespread-fortification represents a massive technological challenge, as most non-invasive oral-delivery approaches suffer from sensory and absorption issues. For example, these fortification approaches do not consider or address the end use of these products such as MN degradation during cooking, MN degradation during storage, or taste-issues stemming from the addition of sensory detectable levels of MNs and/or encapsulants. Independent of the technological challenges, these programs are additionally limited by social and economic constraints such as limited coverage, adherence issues, and cultural issues preventing technology adoption. As such, technologies capable of mitigating fortification issues related to both user end-use and supplier synthesis can improve worldwide fortification programs.

Salt is a universally consumed product and therefore has the potential to deliver vitamins and minerals to those in developing countries. Fortified salt, also known as iodized salt, is table salt (NaCl) mixed with minute amounts of various salts of iodide, to prevent iodine deficiency. Double fortified salt, which is table salt containing iron and iodide, has also been developed. The iron is microencapsulated with stearine to prevent it from reacting with the iodine in the salt. However, adding iron to iodized salt is complicated by a number of chemical, technical, and organoleptic issues, including the tendency of iron to be oxidized in the presence of air.

Fat-soluble vitamins such as vitamin A, D, and E are particularly problematic for storage and distribution under these conditions. They typically exhibit a loss of bioactivity within days and are difficult to formulate due to the oily nature of the molecules, causing agglomeration.

Others have tried encapsulation in polymers and food additives such as poly(meth)acrylates, without success. See, for example, “Eudragit EPO is unsuitable for iron fortification, as even low payloads prevented solid particles formation.” Dueik, V. and Diosady, L. L. (2016), Journal of Food Process Engineering. doi:10.1111/jfpe.12376.

Therefore, it is an object of the invention to provide micronutrient containing compositions containing iron, oil or fat soluble vitamins such as vitamin A, D, and E, water soluble vitamins such as the B vitamins, and/or other micronutrients, and methods of making and using thereof. The micronutrient containing compositions which are stable during processing and storage.

It is a further object of the invention to provide compositions which are stable during food preparation and cooking, and which release the micronutrients at a desired site in the gastrointestinal tract, and methods of making and using thereof.

### SUMMARY OF THE INVENTION

To address the technological (e.g. cooking stability, storage stability, sensory detection) and socio-economic (e.g. implementation, adherence) challenges associated with widespread micronutrient (“MN”)-fortification, a MN delivery technology enhancing the stability of various water- and fat-soluble MNs during storage and cooking conditions has been developed. The technology is a pH-responsive microparticle delivery system capable of encapsulating multiple different MNs, including both water soluble and fat soluble micronutrients, and facilitating rapid release of the MN payloads in acidic gastric conditions both in vitro and in vivo. This technology has been used to successfully deliver bioavailable iron to humans in a clinical trial. Furthermore, a process for the scaled-synthesis of this delivery system using commercially available/sized equipment has also been developed.

Particulate formulations containing iron supplement such as ferrous sulfate, fat or oil soluble vitamins such as vitamin A, D, and E, and/or water soluble vitamins such as the B vitamins, have been developed. These resist oxidation and loss of bioactivity during processing and are resistant to moisture and cooking temperatures. The particles include enteric polymers such as pH-sensitive polymers which degrade or dissolve to release the encapsulated micronutrients at a defined pH range. Preferred pH-sensitive polymers dissolves or degrades at a low pH, such as pH 1-3, preferably 1-2 as found in the stomach.

To prevent oxidation, iron supplement or iron particles containing iron supplement are encapsulated by a protecting polymer such as hyaluronic acid (“HA”), preferably in a ratio of iron:HA of between 1:4 and 1:10, or mixed with a protecting compound such as vitamin C The resulting mixture is then dispersed in a solution of an enteric polymer such as the poly(meth)acrylates marketed as EUDRAGIT®s by BASF, preferably EPO, and manufactured using techniques such as spray drying or spinning disc atomization into particles, typically having a particle size of between one micron and one mm in diameter, preferably about 150 microns in diameter. Typical ranges in the final formulations are Fe: 0.5-3.2%, HA: 2.5-32%, and EPO: 97-64.8%.

To make stable particles containing one or more fat soluble vitamins such as vitamin A, D, and vitamin E, the vitamin is dissolved or dispersed in a solution of an enteric polymer, and then manufactured into particles, using techniques such as spray drying or spinning disc atomization into a powder such as a starch powder which prevents agglomeration and deformation of the particles.

### BRIEF DESCRIPTION OF THE DRAWINGS

FIG. 1A is a schematic of the two-step emulsion process for synthesizing water-soluble MN-MPs. FIG. 1B is a schematic representation of the one-step emulsion process for synthesizing fat-soluble MN-MPs.

FIGS. 2A-2K are graphs of the cumulative release of 11 different individually encapsulated micronutrients from EPO-MPs in room temperature water (circles), boiling water 100° C. (squares), and 37° C. simulated gastric fluid (“SGF”) (triangles). FIG. 2A: vitamin A; FIG. 2B: vitamin D; FIG. 2C: vitamin B2; FIG. 2D: vitamin C; FIG. 2E: zinc (ZnSO₄); FIG. 2F: iodine (KIO₃); FIG. 2G: vitamin B7 (biotin); FIG. 2H: vitamin B3 (niacin); FIG. 2I:vitamin B9 (folic acid); FIG. 2J: vitamin B12; FIG. 2K: iron (FeSO₄). Error bars represent SD (n=3).

FIG. 3 is a graph of the cumulative release of vitamin B12 from HA-EPO MPs in SGF (squares), pH 2 HCl solution (circles), and pH 3 HCl solution (triangles). Error bars represent SD (n=3).

FIGS. 4A and 4B are graphs showing the recovery rate (Recovery %) of individually encapsulated versus unencapsulated (free) micronutrients after exposure to (A) boiling water and (B) light. FIG. 4C is a bar graph showing the time history of color change (ΔE), an indication of a chemical reaction between iron and polyphenols present in banana milk, of lab-scale Fe-HA-EPO MPs versus unencapsulated (free) iron. FIG. 4D is a bar graph showing the recovery rate (Recovery %) of encapsulated (Fe-HA-EPO MPs) versus unencapsulated (free) iron after exposure to boiling water for two hours. FIG. 4E is a bar graph showing the recovery rate (Recovery %) of encapsulated (Fe-HA-EPO MPs) iron after baking. Error bars represent SD (n=3). The “*” signs denote statistical significance (p<0.05) as determined by student t-test.

FIGS. 5A-5H relate to the co-encapsulation of fat- and water-soluble micronutrients in a single formulation. FIG. 5A is a schematic representation of the emulsion process for synthesizing co-encapsulated water-soluble vitamin B9 and vitamin B12 and fat-soluble vitamin A and vitamin D micronutrients in microparticles.

FIGS. 5B-5D are graphs of the percent cumulative release of vitamin B12 (circles), B9 (squares), A (triangles) and D (inverted triangles) in 37° C. simulated gastric fluid (FIG. 5B), room temperature water (FIG. 5C), and boiling water (FIG. 5D).

FIGS. 5E-5G are bar graphs of the percent recovery of micronutrients as determined by HPLC for encapsulated and non-encapsulated fat-soluble MNs after exposure to light (FIG. 5E), fat soluble MNs boiled in water for two hours (FIG. 5F), water soluble MNs boiled in water for two hours (FIG. 5G). FIG. 5H is a bar graph of the percent recovery of micronutrients as determined by biological assays for both fat- and water-soluble co-encapsulated MNs after two hours of boiling in water. Error bars represent SD (n=3).

FIG. 6A is a bar graph showing the quantitative analysis of encapsulated-dye in the stomach, released-dye in the stomach, encapsulated-dye in the intestines, and released-dye in the intestines. Error bars represent SD (n=3). FIG. 6B is a graph showing blood content of radiolabeled vitamin A (% of gavaged dose) over a 6 hour period following oral gavage of free vitamin A (“free VitA”, circles) or vitamin A-loaded EPO MPs (“VitA-BMC”, squares). Error bars represent SEM (n=6).

FIGS. 7A and 7B demonstrate microparticle encapsulated-iron absorption in humans. FIG. 7A is a graph of the relative iron absorption comparing uncooked non-encapsulated iron (triangles) and uncooked iron-loaded HA-EPO-MPs (circles). FIG. 7B is a graph showing relative iron absorption comparing uncooked iron-loaded HA-EPO-MPs (circles) and cooked iron-loaded HA-EPO-MPs (squares). Values represent geometric means+/−SD (n=20). * denotes statistical significance as determined by post-hoc paired student t-test with Bonferroni correction.

FIGS. 8A-8E relate to process development and scale-up production. FIG. 8A is a schematic diagram showing the process for the scaled synthesis of 1 kg of Fe-HA-EPO MPs. FIG. 8B is a graph showing iron release from scaled Fe-HA-EPO MPs in 37° C. SGF, pH 1.5 (triangles), room temperature water (circles), and boiling water (squares). FIG. 8C is a graph showing iron release from 3.19% Fe-HA-EPO MPs (“3.19% Fe-HA-BMC-MPs”) in 37° C. SGF, pH 1.5 (triangles), room temperature water (circles), and boiling water (squares). FIG. 8D is a graph showing iron release 18.29% Fe-HA-EPO MPs (“18.29% Fe-HA-EPO MPs”) in 37° C. SGF, pH 1.5 (triangles), room temperature water (circles), and boiling water (squares). FIG. 8E is a graph showing the sensory performance of scaled Fe-HA-EPO MPs and their individual constituents in a food matrix (banana milk), compared to FeSO₄ and FePP (ferric pyrophosphate), at 60 ppm Fe. “BMC” refers to EPO. Absolute color change ΔE±SD is given at 120 min against the non-fortified matrix. Horizontal line represent the threshold for which below, ΔE cannot be detected.

FIG. 9A is a graph showing vitamin A release from vitamin-loaded EPO MPs manufactured by spinning disc atomization into starch (“VitA-EPO-Starch”) in 37° C. SGF, pH 1.5 (triangles), room temperature water (circles), and boiling water (squares). FIG. 9B is a bar graph comparing the percent recovery of vitamin A encapsulated in VitA-EPO-Starch MPs or free vitamin A after boiling in water for two hours. FIGS. 9C-9G are bar graphs showing percent recovery of vitamin A from four different formulations under different conditions including (1) 40° C., 75 humidity (FIG. 9C), (2) exposure to sunlight at room temperature (FIG. 9D), (3) suspended in water at room temperature (FIG. 9E), (4) suspended in water at 4° C. (FIG. 9F), and (5) 15° C., 75% humidity (FIG. 9G). The four formulations are lab-scale vitamin A-loaded EPO MPs (“VitA-EPO”, circles), a commercially available vitamin A formulation (“BASF 250”, squares), and scale-up vitamin A-loaded EPO MPs (“VitA-EPO-Starch”, triangles), and free vitamin A (inverse triangles).

FIG. 10 is a schematic diagram showing the workflow manufacturing vitamin A-loaded EPO powder via extrusion.

FIG. 11A shows the bioavailability of iron from Fe-HA-EPO MPs with high loads in humans. Iron bioavailability as assessed by erythrocyte iron incorporation in young women (n=24) following ingestion of free iron as FeSO₄ (circles), 3.19% Fe-HA-EPO MPs (squares), and 18.29% Fe-HA-EPO MPs (triangles). “BMC” refers to EPO. The values are expressed as a percentage of the total amount of iron that was ingested. Bars represent geometric means (n=24) and 95% confidence intervals. *(p <0.05) or **(p<0.01). Significant effect of meal on iron absorption determined by linear mixed models, participants as random intercept, meal as repeated fixed factor, and post-hoc paired comparisons with Bonferroni correction (p<0.05).

FIG. 11B shows the bioavailability of iron from 3.19% Fe-HA-EPO MPs in humans when co-administered with other EPO MPs. Iron bioavailability as assessed by erythrocyte iron incorporation in young women (n=24) following ingestion of 3.19% Fe-HA-EPO MPs (circles), 3.19% Fe-HA-EPO MPs with VitA-EPO MPs (squares), and 3.19% Fe-HA-EPO MPs with VitA-EPO MPs and free folic acid. “BMC” refers to EPO. These values are expressed as a percentage of the total amount of iron that was ingested. Bars represent geometric means (n=24). Significant effect of meal on iron absorption determined by linear mixed models, participants as random intercept, meal as repeated fixed factor, and post-hoc paired comparisons with Bonferroni correction (p<0.05).

FIG. 11C shows a comparison of iron absorption from 3.19% Fe-HA-EPO MPs with each MP constituent both individually and in combination. Iron bioavailability as assessed by erythrocyte iron incorporation in young women (n=24) following ingestion of 3.19% Fe-HA-EPO MPs (circles), 8.75% Fe-HA MPs (squares), free iron with free HA (triangels), free iron with free EPO (diamonds), free iron with free HA and free EPO (stars), free iron (crossbars). “BMC” refers to EPO. These values are expressed as a percentage of the total amount of iron that was ingested. Bars represent geometric means (n=24) and 95% confidence intervals. Significant effect of meal on iron absorption determined by linear mixed models, participants as random intercept, meal as repeated fixed factor, with post-hoc paired comparisons with Bonferroni correction, *(p<0.05) or **(p<0.005).

FIGS. 12A and 12B are related to iron transported across a human in vitro intestinal barrier model following addition of iron in the presence of varying amounts of MP constituents HA (FIG. 12A) and EPO (FIG. 12B) and expressed as a percentage of transported free iron. Error bars represent SD (n=3).

### DETAILED DESCRIPTION OF THE INVENTION

### I. Definitions

“pH-sensitive” as used herein generally refers to materials, such as polymers, whose dissolution properties are pH-dependent.

“Water-insoluble”, as used herein, as used herein means that a material, such as a polymer, does not dissolve in aqueous solutions or buffers above pH 5.

“Water-soluble”, as used herein, means a material, such as a vitamin that can dissolve in water. Water-soluble vitamins are carried to the body's tissues but are not stored in the body. They are found in plant and animal foods or dietary supplements and must be taken in daily. Vitamin C and members of the vitamin B complex are water-soluble.

“Fat-soluble”, as used herein, means a material, such as a vitamin that can dissolve in fats and oils. Fat-soluble vitamins are absorbed along with fats in the diet and can be stored in the body's fatty tissue. They come from plant and animal foods or dietary supplements. Vitamins A, D, E, and K are fat-soluble.

“Thermally stable” as used herein, generally means that a material is chemically and/or physically stable (e.g., does not degrade) at a given temperature, such as at temperatures encountered during food preparation and/or cooking (e.g., up to and including boiling) for a period of at least about ten to twenty minutes, for example, up to about two to about four hours. In some forms. the thermally stable polymer coating does not degrade and allow leakage of the materials from the core at cooking temperatures.

The criteria for stability of an iron micronutrient formulation is that the iron does not oxidize to the point where it loses more than 50%, 60%, 70%, 80%, 90% or 100% of its bioactivity as compared to the bioactivity when encapsulated when exposed to boiling water for two hours or subjected to long term (sixty days) exposure to 75% humidity and 40° C.

The criteria for stability of a fat soluble vitamin such as vitamin A, vitamin D, or vitamin E micronutrient formulation is that the vitamin does not lose more than 50%, 60%, 70%, 80%, 90% or 100% of its bioactivity as compared to the bioactivity when encapsulated when exposed to boiling water for two hours or subjected to long term (sixty days) exposure to 75% humidity and 40° C.

“Stable at storage temperature” as used herein generally means that a material is chemically and/or physically stable (e.g., does not degrade) from about −4° C. (e.g., refrigerator temperature) to about 25-35° C., with a humidity of about 40-60%.

“Micronutrient”, as used herein, generally refers to a substance, such as a vitamin or mineral that is essential in minute amounts (e.g., less than 100 mg/day) for the proper growth and metabolism of a living organism, such as a human “Micronutrient” includes both microminerals or trace elements and microvitamins

The term “diameter” is art-recognized and is used herein to refer to either of the physical diameter or the hydrodynamic diameter. As used herein, the diameter of a non-spherical particle may refer to the largest linear distance between two points on the surface of the particle. When referring to multiple particles, the diameter of the particles or the capsules typically refers to the average diameter of the particles. Diameter of particles can be measured using a variety of techniques, including but not limited to the optical or electron microscopy, as well as dynamic light scattering and filtration.

The term “biocompatible” as used herein refers to one or more materials that are neither themselves toxic to the host (e.g., a non-human animal or human), nor degrade (if the material degrades) at a rate that produces monomeric or oligomeric subunits or other byproducts at toxic concentrations in the host.

The term “biodegradable” as used herein means that the materials degrades or breaks down into its component subunits, or digestion, e.g., by a biochemical process, of the material into smaller (e.g., non-polymeric) subunits.

The term “microparticles” is art-recognized, and includes microspheres and microcapsules, as well as structures that may not be readily placed into either of the above two categories, all with dimensions on average of less than about 1000 microns. A microparticle may be spherical or nonspherical and may have any regular or irregular shape. If the structures are less than about one micron in diameter, then the corresponding art-recognized terms “nanosphere,” “nanocapsule,” and “nanoparticle” may be utilized. In certain embodiments, the nanospheres, nanocapsules and nanoparticles have an average diameter of about 500 nm, about 200 nm, about 100 nm, about 50 nm, about 10 nm, or about 1 nm.

“Matrix” as used herein generally refers to one or more solid or semi-solid material in which is embedded one or more others materials.

“Hydrogel” as used herein is a network of polymer chains that are hydrophilic, sometimes found as a colloidal gel in which water is the dispersion medium. Hydrogels are highly absorbent (they can contain over 90% water) natural or synthetic polymeric networks. Hydrogels also possess a degree of flexibility very similar to natural tissue, due to their significant water content.

### II. Stabilized Micronutrient Formulations

Particulate formulations containing one or more micronutrients, such as iron supplement such as ferrous sulfate, water soluble vitamins such as vitamin C and members of B vitamins, and fat or oil soluble vitamins such as vitamin A, D, and E, have been developed. These resist oxidation and loss of bioactivity during processing and are resistant to moisture and cooking temperatures. The particles include one or more enteric polymers such as pH-sensitive polymers which degrade/dissolve and release the encapsulated micronutrients at a defined pH range. Preferred pH-sensitive polymers release at a low pH, such as pH 1-3, preferably 1-2 as found in the stomach.

To prevent oxidation, the iron supplement or iron particles containing the iron supplement are encapsulated by a protecting polymer such as hyaluronic acid (“HA”), preferably in a ratio of iron:HA of between 1:4 and 1:10, or mixed with a protecting compound such as vitamin C The resulting mixture is then dispersed in a solution of an enteric polymer such as the poly(meth)acrylates marketed as EUDRAGIT®s by BASF, preferably EPO, and manufactured using techniques such as spray drying or spinning disc atomization into particles, typically having a particle size of between one micron and one mm in diameter, preferably about 150 microns in diameter. Typical ranges in the final formulation are Fe: 0.5-3.2%, HA: 2.5-32% and. EPO: 97-64.8%.

To make stable particles containing one or more fat soluble micronutrients such as fat soluble vitamins such as vitamin A, D, and vitamin E, the micronutrient is dissolved or dispersed in a solution of an enteric polymer, and then manufactured into particles, using microencapsulation techniques such as spray drying or spinning disc atomization into a powder such as a starch powder which prevents agglomeration and deformation of the particles.

To make stable particles containing one or more water soluble micronutrients such as water soluble vitamins such as vitamin C, B3, B7, B9, and B12 and trace elements such as zinc and iodine, the micronutrient is encapsulated in a first matrix formed by a hydrophilic or amphiphilic polymer such as hyaluronic acid or gelatin. The particles containing the water soluble micronutrient are further coated or encapsulated by a second matrix formed by an enteric polymer, using microencapsulation techniques such as spray drying or spinning disc atomization into a powder such as a starch powder which prevents agglomeration and deformation of the particles.

Formulations are made up of one or more micronutrients distributed in a first matrix which is coated or encapsulated by a second matrix formed by one or more pH-sensitive, thermally stable materials. In some forms, the micronutrient is directly coated or encapsulated with one or more pH-sensitive, thermally stable materials to form microparticles. The pH-sensitive, thermally stable materials help to stabilize the vitamins and trace minerals, particularly at high temperatures, such as during preparation and cooking, and effectively release the vitamins and micronutrients at the desired locations after ingestion (e.g., stomach, small intestine, etc.).

Methods have been developed which allow co-encapsulation of fat-soluble MNs with water-soluble MNs.

Particles or seeds are formed of the one or more micronutrients. The diameter of the particles or seeds can vary. However, in some embodiments, the average diameter is from about a few nanometers up to about 1000 microns, preferably from a few nanometers to about 500 microns.

A. Micronutrients

Exemplary micronutrients include, but are not limited to, iron, cobalt, zinc, manganese, copper, iodine, selenium, molybdenum, chromium, vitamin

A, beta carotene, vitamin B1, vitamin B2 (riboflavin), vitamin B3 (niacin), vitamin B6, vitamin B7 (biotin), vitamin B9 (folic acid), vitamin B12, vitamin C, vitamin D3, vitamin E, vitamin K, pantothenic acid, and combinations thereof. The required daily dosage of most micronutrients is less than 100 mg/day. Recommended values are shown in Table 1, from the US Department of Agriculture 2013.

Vitamin A is involved in physiological processes that result in cellular differentiation, cellular maturity, and cellular specificity. Vitamin A is an important component of a nutritional supplement for subjects in physiologically stressful states, such as those caused by pregnancy, lactation or disease state. Vitamin A may be included in the form of acetate. 100% recommended dietary allowance (RDA) for children 6-59 months old is 0.9 mg/day. 50% RDA for an adult female is 0.45 mg/day. Useful forms of vitamin A for the disclosed formulations include retinyl palmitate, retinyl acetate, and beta-carotene.

Beta-carotene is converted to vitamin A within the body as needed. Beta-carotene also has powerful antioxidant properties. Antioxidants are important during physiologically stressful events for numerous reasons. For example, lipid peroxidation has been associated with over 200 disease processes. Antioxidants are especially important during pregnancy because in the first trimester, establishment of blood flow into the intervillous space is associated with a burst of oxidative stress. The inability to mount an effective antioxidant defense against this burst results in early pregnancy loss. Further, oxidative stress has been implicated in the pathophysiology of preeclampsia, a toxemia of pregnancy. Finally, oxidative stress during pregnancy plays an important role in fetal growth, and healthy antioxidant levels are positively correlated with birth weight and length.

B-complex contains water-soluble nutrients generally not stored in the body. They play roles in a variety of biological processes critical to the health of pregnant women, lactating women, and fetuses such as, for example, the metabolism of homocysteine. The B-complex vitamins contain one or more of vitamin B1, vitamin B2, vitamin B3, vitamin B6, vitamin B7, vitamin B9, and vitamin B12. B vitamins often work in concert with each other, and multiple B vitamin deficiencies are assumed more common than single B vitamin deficiencies.

Vitamin B1 μlays a role in carbohydrate metabolism and neural function. It is a coenzyme for the oxidative decarboxylation of alpha-ketoacids (e.g., alpha-ketoglutarate and pyruvate) and for transketolase, which is a component of the pentose phosphate pathway. Vitamin B1 may be included in the form of thiamine mononitrate.

TABLE 1
Dietary Reference Intakes (DRIs)
Dietary Reference Intakes (DRIs): Estimated Average Requirements
Food and Nutrition Board, Institute of Medicine, National Academies

| | | | | | | | | | | Ribo- | | | |
|---|---|---|---|---|---|---|---|---|---|---|---|---|---|
| Life Stage | | Calcium | CTIO | Protein | Vit A | Vit C | Vit D | Vit E | Thiamin | flavin | Niacin | Vit B₆ | Folate |
| Group | | (mg/d) | (g/d) | (g/kg/d) | (μg/d)^{a} | (mg/d) | (μg/d) | (mg/d)^{b} | (mg/d) | (mg/d) | (mg/d)^{c} | (mg/d) | (μg/d)^{d} |
| Infants | | | | | | | | | | | | | |
| 0 to 6 | mo | | | | | | | | | | | | |
| 6 to 12 | mo | | | 1.0 | | | | | | | | | |
| Children | | | | | | | | | | | | | |
| 1-3 | y | 500 | 100 | 0.87 | 210 | 13 | 10 | 5 | 0.4 | 0.4 | 5 | 0.4 | 120 |
| 4-8 | y | 800 | 100 | 0.76 | 275 | 22 | 10 | 6 | 0.5 | 0.5 | 6 | 0.5 | 160 |
| Males | | | | | | | | | | | | | |
| 9-13 | y | 1,100 | 100 | 0.76 | 445 | 39 | 10 | 9 | 0.7 | 0.8 | 9 | 0.8 | 250 |
| 14-18 | y | 1,100 | 100 | 0.73 | 630 | 63 | 10 | 12 | 1.0 | 1.1 | 12 | 1.1 | 330 |
| 19-30 | y | 800 | 100 | 0.66 | 625 | 75 | 10 | 12 | 1.0 | 1.1 | 12 | 1.1 | 320 |
| 31-50 | y | 800 | 100 | 0.66 | 625 | 75 | 10 | 12 | 1.0 | 1.1 | 12 | 1.1 | 320 |
| 51-70 | y | 800 | 100 | 0.66 | 625 | 75 | 10 | 12 | 1.0 | 1.1 | 12 | 1.4 | 320 |
| >70 | y | 1,000 | 100 | 0.66 | 625 | 75 | 10 | 12 | 1.0 | 1.1 | 12 | 1.4 | 320 |
| Females | | | | | | | | | | | | | |
| 9-13 | y | 1,100 | 100 | 0.76 | 420 | 39 | 10 | 9 | 0.7 | 0.8 | 9 | 0.8 | 250 |
| 14-18 | y | 1,100 | 100 | 0.71 | 485 | 56 | 10 | 12 | 0.9 | 0.9 | 11 | 1.0 | 330 |
| 19-30 | y | 800 | 100 | 0.66 | 500 | 60 | 10 | 12 | 0.9 | 0.9 | 11 | 1.1 | 320 |
| 31-50 | y | 800 | 100 | 0.66 | 500 | 60 | 10 | 12 | 0.9 | 0.9 | 11 | 1.1 | 320 |
| 51-70 | y | 1,000 | 100 | 0.66 | 500 | 60 | 10 | 12 | 0.9 | 0.9 | 11 | 1.3 | 320 |
| >70 | y | 1,000 | 100 | 0.66 | 500 | 60 | 10 | 12 | 0.9 | 0.9 | 11 | 1.3 | 320 |
| Pregnancy | | | | | | | | | | | | | |
| 14-18 | y | 1,000 | 135 | 0.88 | 530 | 66 | 10 | 12 | 1.2 | 1.2 | 14 | 1.6 | 520 |
| 19-30 | y | 800 | 135 | 0.88 | 550 | 70 | 10 | 12 | 1.2 | 1.2 | 14 | 1.6 | 520 |
| 31-50 | y | 800 | 135 | 0.88 | 550 | 70 | 10 | 12 | 1.2 | 1.2 | 14 | 1.6 | 520 |
| Lactation | | | | | | | | | | | | | |
| 14-18 | y | 1,000 | 160 | 1.05 | 885 | 96 | 10 | 16 | 1.2 | 1.3 | 13 | 1.7 | 450 |
| 19-30 | y | 800 | 160 | 1.05 | 900 | 100 | 10 | 16 | 1.2 | 1.3 | 13 | 1.7 | 450 |
| 31-50 | y | 800 | 160 | 1.05 | 900 | 100 | 10 | 16 | 1.2 | 1.3 | 13 | 1.7 | 450 |

| | | | Vit | | | | | | | | |
|---|---|---|---|---|---|---|---|---|---|---|---|
| | Life Stage | | B₁₂ | Copper | Iodine | Iron | Magnesium | Molybdenum | Phosphorus | Selenium | Zinc |
| | Group | | (μg/d) | (μg/d) | (μg/d) | (mg/d) | (mg/d) | (μg/d) | (mg/d) | (μg/d) | (mg/d) |
| | Infants | | | | | | | | | | |
| | 0 to 6 | mo | | | | | | | | | |
| | 6 to 12 | mo | | | | 6.9 | | | | | 2.5 |
| | Children | | | | | | | | | | |
| | 1-3 | y | 0.7 | 260 | 65 | 3.0 | 65 | 13 | 380 | 17 | 2.5 |
| | 4-8 | y | 1.0 | 340 | 65 | 4.1 | 110 | 17 | 405 | 23 | 4.0 |
| | Males | | | | | | | | | | |
| | 9-13 | y | 1.5 | 540 | 73 | 5.9 | 200 | 26 | 1,055 | 35 | 7.0 |
| | 14-18 | y | 2.0 | 685 | 95 | 7.7 | 340 | 33 | 1,055 | 45 | 8.5 |
| | 19-30 | y | 2.0 | 700 | 95 | 6 | 330 | 34 | 580 | 45 | 9.4 |
| | 31-50 | y | 2.0 | 700 | 95 | 6 | 350 | 34 | 580 | 45 | 9.4 |
| | 51-70 | y | 2.0 | 700 | 95 | 6 | 350 | 34 | 580 | 45 | 9.4 |
| | >70 | y | 2.0 | 700 | 95 | 6 | 350 | 34 | 580 | 45 | 9.4 |
| | Females | | | | | | | | | | |
| 9-13 | | y | 1.5 | 540 | 73 | 5.7 | 200 | 26 | 1,055 | 35 | 7.0 |
| 14-18 | | y | 2.0 | 685 | 95 | 7.9 | 300 | 33 | 1,055 | 45 | 7.3 |
| 19-30 | | y | 2.0 | 700 | 95 | 8.1 | 255 | 34 | 580 | 45 | 6.8 |
| 31-50 | | y | 2.0 | 700 | 95 | 8.1 | 265 | 34 | 580 | 45 | 6.8 |
| 51-70 | | y | 2.0 | 700 | 95 | 5 | 265 | 34 | 580 | 45 | 6.8 |
| >70 | | y | 2.0 | 700 | 95 | 5 | 265 | 34 | 580 | 45 | 6.8 |
| | Pregnancy | | | | | | | | | | |
| | 14-18 | y | 2.2 | 785 | 160 | 23 | 335 | 40 | 1,055 | 49 | 10.5 |
| | 19-30 | y | 2.2 | 800 | 160 | 22 | 290 | 40 | 580 | 49 | 9.5 |
| | 31-50 | y | 2.2 | 800 | 160 | 22 | 300 | 40 | 580 | 49 | 9.5 |
| | Lactation | | | | | | | | | | |
| | 14-18 | y | 2.4 | 985 | 209 | 7 | 300 | 35 | 1,055 | 59 | 10.9 |
| | 19-30 | y | 2.4 | 1,000 | 209 | 6.5 | 255 | 36 | 580 | 59 | 10.4 |
| | 31-50 | y | 2.4 | 1,000 | 209 | 6.5 | 265 | 36 | 580 | 59 | 10.4 |

NOTE:
An Estimated Average Requirement (EAR) is the average daily nutrient intake level estimated to meet the requirements of half of the healthy individuals in a group. EARs have not been established for vitamin K. pantothenic acid, biotin, choline, chromium, fluoride, manganese, or other nutrients not yet evaluated via the DRI process.
^{a}As retinol activity equivalents (RAEs). 1 RAE = 1 μg retinol, 12 μg β-carotene, 24 μg α-carotene, or 24 μg β-cryptoxanthin. The RAE for dietary provitamin A carotenoids is two-fold greater than retinol equivalents (RE), whereas the RAE for preformed vitamin A is the same as RE.
^{b}As α-tocopherol. α-Tocopherol includes RRR-α-tocopherol, the only form of α-tocopherol that occurs naturally in foods, and the 2R-stereoisomeric forms of α-tocopherol (RRR-, RSR-, RRS-, and RSS-α-tocopherol) that occur in fortified foods and supplements. It does not include the 2S-stereoisomeric forms of α-tocopherol (SRR-, SSR-, SRS-, and SSS-α-tocopherol), also found in fortified foods and supplements.
^{c}As niacin equivalents (NE). 1 mg of niacin = 60 mg of tryptophan.
^{d}As dietary folate equivalents (DFE). 1 DFE = 1 μg food folate = 0.6 μg of folic acid from fortified food or as a supplement consumed with food = 0.5 μg of a supplement taken on an empty stomach.
SOURCES: Dietary Reference Intakes for Calcium, Phosphorous, Magnesium, Vitamin D, and Fluoride (1997); Dietary Reference Intakes for Thiamin, Riboflavin, Niacin, Vitamin B₆, Folate, Vitamin B₁₂, Pantothenic Acid. Biotin, and Choline (1998); Dietary Reference Intakes for Vitamin C, Vitamin E, Selenium, and Carotenoids (2000); Dietary Reference Intakes for Vitamin A, Vitamin K, Arsenic, Boron, Chromium, Copper, Iodine, Iron, Manganese, Molybdenum, Nickel, Silicon, Vanadium, and Zinc (2001); Dietary Reference Intakes for Energy, Carbohydrate, Fiber, Fat, Fatty Acids, Cholesterol, Protein, and Amino Acids (2002/2005); and Dietary Reference Intakes for Calcium and Vitamin D (2011). These reports may be accessed via www.nap.cdu.

Vitamin B2 is a component of two flavin coenzymes, flavin mononucleotide (FMN) and flavin adenine dinucleotide (FAD). These flavoenzymes are involved in a number of oxidation-reduction reactions including the conversion of pyridoxine and niacin. Flavoenzymes also play a role in a number of metabolic pathways such as amino acid deamination, purine degradation and fatty acid oxidation and thus help to maintain carbohydrate, amino acid and lipid metabolism. Vitamin B2 may be included in the form of riboflavin.

Vitamin B3, or “niacin,” is the common name for two compounds: nicotinic acid (also called niacin) and niacinamide (also called nicotinamide). Vitamin B3 is important for maintaining healthy levels and types of fatty acids. It is also required for the synthesis of pyroxidine, riboflavin, and folic acid. Administration of vitamin B3 also may effect a reduction in total cholesterol (LDL) and very low-density lipoprotein (VLDL) levels and an increase in high-density lipoprotein (HDL) cholesterol levels. Nicotinamide adenine dinucleotide (NAD) and NAD phosphate (NADP) are active coenzymes of niacin. These coenzymes are involved in numerous enzymatic reactions such as glycolysis, fatty acid metabolism, and steroid synthesis. Vitamin B3 may be included in the form of niacinamide In another embodiment, the formulation may include an equivalent molar amount of niacin or a combination of niacin and nicotinamide.

Vitamin B6 may reduce the levels of homocysteine. The active forms of vitamin B6, pyridoxal-5′-phosphate (PLP) and pyridoxamine-5′-phosphate, are coenzymes for numerous enzymes and as such, are important for gluconeogenesis, niacin formation, and erythrocyte metabolism. Vitamin B6 is a coenzyme for both cystathionine synthase and cystathionase, enzymes that catalyze the formation of cysteine from methionine. Homocysteine is an intermediate in this process and elevated levels of plasma homocysteine are recognized as a risk factor for both vascular disease and neural tube defects. Vitamin B6 may be included in the form of pyridoxine hydrochloride.

Vitamin B9 can prevent neural tube defects such as spina bifida caused by disturbed homocysteine metabolism. Vitamin B9 also is important for the formation of red and white blood cells within bone marrow and plays a role in heme formation. Further, folate deficiencies inhibit the activity of vitamin B1. Vitamin B9 may be included in the forms of folic acid, folacin, metafolin, folate and/or one or more natural isomers of folate including (6S)-tetrahydrofolic acid or a polyglutamyl derivative thereof, 5-methyl-(6S)-tetrahydrofolic acid or a polyglutamyl derivative thereof, 5-formyl-(6S)-tetrahydrofolic acid or a polyglutamyl derivative thereof, 10-formyl-(6R)-tetrahydrofolic acid or a polyglutamyl derivative thereof, 5,10-methylene-(6R)-tetrahydrofolic acid or a polyglutamyl derivative thereof, 5,10-methenyl-(6R)-tetrahydrofolic acid or a polyglutamyl derivative thereof, and 5-formimino-(6S)-tetrahydrofolic acid or a polyglutamyl derivative thereof. 100% RDA for children 6-59 months old is 0.15 mg/day. 50% RDA for an adult female is 0.2 mg/day. A useful form of vitamin B9 for the disclosed formulations is folic acid.

Vitamin B12 can be converted to the active coenzymes, methylcobalamin and 5′-deoxyadenosylcobalamin. These coenzymes are necessary for folic acid metabolism, conversion of coenzyme A and myelin synthesis. Methylcobalamin also catalyzes the demethylation of a folate cofactor, which is involved in DNA synthesis. A lack of demethylation may result in folic acid deficiency. Deoxyadenosylcobalamin is the coenzyme for the conversion of methylmalonyl-CoA to succinyl-CoA, which plays a role in the citric acid cycle. Cobalamin, along with pyridoxine and folic acid, also are implicated in the proper metabolism of homocysteine, a breakdown product of the amino acid methionine, which is correlated with an increased risk of heart disease due to its negative effects on endothelial function. Vitamin B12 may be included in the form of cyanocobalamin. 100% RDA for children 6-59 months old is 0.0009 mg/day. 50% RDA for an adult female is 0.0012 mg/day. Useful forms of vitamin B12 for the disclosed formulations include cyanocobalamin and methylcobalamin.

Vitamin C is a co-substrate in metal catalyzed hydroxylations. Like beta-carotene, vitamin C has antioxidant properties. It interacts directly with superoxide hydroxyl radicals and singlet oxygen, and also provides antioxidant protection for folate and vitamin E, keeping vitamin E in its most potent form. Vitamin C may afford protective effects against preeclampsia by participating in the scavenging of free radicals. Indeed, significantly lower levels of vitamin C have been observed in preeclamptic women than in controls.

Vitamin C also enhances the absorption of iron. In addition, vitamin C is required for collagen synthesis, epinephrine synthesis, and bile acid formation. Moreover, vitamin C has been implicated in inhibiting atherosclerosis by being present in extracellular fluid of the arterial wall and potentiating nitric oxide activity, thus normalizing vascular function. Vitamin C may be included in the form of ascorbic acid. 100% RDA for children 6-59 months old is 30 mg/day. 50% RDA for an adult female is 37.5 mg/day. Useful forms of vitamin C for the disclosed formulations include ascorbic acid and sodium ascorbate.

Vitamin D3 is a fat-soluble “hormone like” substance important for the maintenance of healthy bones. This vitamin increases the absorption of calcium and phosphorous from the gastrointestinal tract, and improves mineral resorption into bone tissue. Vitamin D can be converted to its active form from exposure of the skin to sunlight. Deficiencies in vitamin D3 can lead to increased bone turnover and loss, and when severe, osteomalacia, or softening of the bones. Supplementation with vitamin D3 has been shown to moderately reduce bone loss, increase serum 25-hydroxyvitamin D, and decrease serum parathyroid hormone levels. Vitamin D3 also plays a role in the maintenance of calcium and phosphorus homeostasis, but it is also active in cell differentiation and immune function. Vitamin D3 may be included in the form of cholecalciferol. 100% RDA for children 6-59 months old is 0.005 mg/day. 50% RDA for an adult female is 0.0075 mg/day. Useful forms of vitamin D for the disclosed formulations include cholecalciferol and ergocalciferol.

Vitamin E is a fat-soluble vitamin antioxidant found in biological membranes where it protects the phospholipid membrane from oxidative stress. Vitamin E inhibits the oxidation of unsaturated fatty acids by trapping peroxyl free radicals. It is also an antiatherogenic agent, and studies have demonstrated a reduced risk of coronary heart disease with increased intake of vitamin E In addition, vitamin E, like beta-carotene and vitamin C, may afford protective effects against preeclampsia by participating in the scavenging of free radicals. As with vitamin C, significantly lower levels of vitamin E have been observed in preeclamptic women than in controls. Vitamin E may be included in the form of d-alpha-tocopheryl acetate or d-alpha tocopheryl succinate.

Iron is necessary to carry oxygen to bodily tissues via the hemoglobin part of red blood cells. Supplemental intake of iron is critical to preventing anemia, a disorder associated with a variety of physiological states including, for example, pregnancy or high parasite infestation. The formulations may include iron in either chelated or nonchelated form. Iron may be included in the form of a polysaccharide iron complex. In another embodiment, iron may be included in the form of an equivalent molar amount of ferrous fumarate or ferrous sulfate. 100% RDA for children 6-59 months old is 10 mg/day. 50% RDA for an adult female is 9 mg/day. Useful forms of iron include NaFeEDTA, ferrous sulfate, ferrous gluconate, ferrous fumarate, and ferric pyrophosphate.

Magnesium is found primarily in both bone and muscle and is important for over 300 different enzyme reactions. A primary function of magnesium is to bind to phosphate groups in adenosine triphosphate (ATP), thereby forming a complex that assists in the transfer of ATP phosphate. Magnesium also functions within cells as a membrane stabilizer. Magnesium plays roles in nucleic acid synthesis, glycolysis, transcription of DNA and RNA, amino acid activation, membrane transport, transketolase reactions, and protein synthesis. It is also involved in the formation of cAMP, a cytosolic second messenger that plays a role in cell signaling mechanisms. Magnesium also functions both synergistically and antagonistically with calcium in neuromuscular transmission. Specifically, magnesium is critical for the maintenance of electrochemical potentials of nerve and muscle membranes and the neuromuscular junction transmissions, particularly important in the heart. Not surprisingly, magnesium deficiency is tied to cardiovascular disease and hypertension. Indeed, oral magnesium therapy improves endothelial function in patients with coronary disease.

Magnesium is available in a variety of salts and can be included in the formulations in either chelated or nonchelated form. In one embodiment, magnesium is included in the form of magnesium oxide.

Zinc plays a role in numerous metabolic activities such as nucleic acid production, protein synthesis, and development of the immune system. There are more than 200 zinc metalloenzymes including aldolase, alcohol dehydrogenase, RNA polymerase, and protein kinase C. Zinc stabilizes RNA and DNA structures, forms zinc fingers in nuclear receptors, and is a component of chromatin proteins involved in transcription and replication. Deficiencies of zinc during pregnancy have been shown to contribute to severe fetal abnormalities. Zinc is available in many forms and may be included in the formulations in chelated or nonchelated form. In one embodiment, zinc may be included in the form of zinc oxide. 100% RDA for children 6-59 months old is 4.1 mg/day. 50% RDA for an adult female is 8 mg/day. Useful forms of zinc for the disclosed formulations include zinc acetate, zinc gluconate, zinc picolinate, and zinc sulfate.

Selenium is an essential micronutrient for animals. Selenium is a component of the amino acids selenocysteine and selenomethionine. Selenium functions as cofactor for reduction of antioxidant enzymes, such as glutathione peroxidases and certain forms of thioredoxin reductase. The glutathione peroxidase family of enzymes (GSH-Px) catalyzes certain reactions that remove reactive oxygen species such as hydrogen peroxide and organic hydroperoxides.

Selenium also plays a role in the functioning of the thyroid gland and in every cell that uses thyroid hormone, by participating as a cofactor for the three of the four known types of thyroid hormone deiodinases, which activate and then deactivate various thyroid hormones and their metabolites: the iodothyronine deiodinases are the subfamily of deiodinase enzymes that use selenium as the otherwise rare amino acid selenocysteine. Selenium may inhibit Hashimoto's disease, in which the body's own thyroid cells are attacked as alien.

Manganese is an essential trace nutrient. The classes of enzymes that have manganese cofactors are very broad, and include oxidoreductases, transferases, hydrolases, lyases, isomerases, ligases, lectins, and integrins.

Copper is an essential trace element in animals. Because of its role in facilitating iron uptake, copper deficiency can produce anemia-like symptoms, neutropenia, bone abnormalities, hypopigmentation, impaired growth, increased incidence of infections, osteoporosis, hyperthyroidism, and abnormalities in glucose and cholesterol metabolism.

Cobalt is an essential trace element. It is a key constituent of cobalamin, also known as vitamin B12, which is the primary biological reservoir of cobalt as an “ultratrace” element. The cobalamin-based proteins use corrin to hold the cobalt. Coenzyme B12 features a reactive C-Co bond, which participates in its reactions. In humans, B12 exists with two types of alkyl ligand: methyl and adenosyl. MeB12 promotes methyl (—CH₃) group transfers. The adenosyl version of B12 catalyzes rearrangements in which a hydrogen atom is directly transferred between two adjacent atoms with concomitant exchange of the second substituent, X, which may be a carbon atom with substituents, an oxygen atom of an alcohol, or an amine Methylmalonyl coenzyme A mutase (MUT) converts MM1-CoA to Su-CoA, an important step in the extraction of energy from proteins and fats.

Iodine's main role in animal biology is as a constituent of the thyroid hormones thyroxine (T4) and triiodothyronine. These are made from addition condensation products of the amino acid tyrosine, and are stored prior to release in an iodine-containing protein called thyroglobulin. T4 and T3 contain four and three atoms of iodine per molecule, respectively. The thyroid gland actively absorbs iodide from the blood to make and release these hormones into the blood, actions that are regulated by a second hormone. Thyroid hormones play a basic role in biology, acting on gene transcription to regulate the basal metabolic rate. The total deficiency of thyroid hormones can reduce basal metabolic rate up to 50%, while in excessive production of thyroid hormones the basal metabolic rate can be increased by 100%.

Iodine has a nutritional relationship with selenium. A family of selenium-dependent enzymes called deiodinases converts T4 to T3 (the active hormone) by removing an iodine atom from the outer tyrosine ring. These enzymes also convert T4 to reverse T3 (rT3) by removing an inner ring iodine atom, and convert T3 to 3,3′-diiodothyronine (T2) also by removing an inner ring atom. It is also important for fetal and neonatal development. 100% RDA for children 6-59 months old is 0.09 mg/day. 50% RDA for an adult female is 0.075 mg/day. Useful forms of iodine for the disclosed formulations include sodium iodide and potassium iodate.

Other therapeutic, nutritional, prophylactic or diagnostic agents can also be included. In one embodiment, anti-parasitic agents are incorporated into the particles. Anti-parasitic agents, such as anti-protozoa agents, antihelminthics, and combinations thereof, include, but are not limited to, antinematodes, anticestodes, antitrematodes, antiamoebics, antiprotozoals, and combinations thereof.

Suitable antinematodal drugs include, but are not limited to, benzimiadazoles (e.g., mebendazole, thiabendazole), avermectins (e.g., ivermectin), pyrantel pamoate, diethylcarbamazine, and combinations thereof.

Suitable anticestodes include, but are not limited to, niclosamine, praziquantel, albendazole, and combinations thereof.

Suitable antitrematodes include, but are not limited to, praziquantel.

Suitable antiamoebics include, but are not limited to, rifampin, amphotericin B, and combinations thereof.

Suitable antiprotozoals include, but are not limited to, melarsoprol, eflornithine, metronidazole, tinidazole, miltefosine, and combinations thereof.

The particles can contain one or more antiviral and/or antimicrobial agents. Suitable agents include anti-influenza agents, anti-poliovirus agents, antihepatitis agents, anti-arboroviral agents (anthropod-borne viruses such as dengue fever, yellow fever, and malaria), anti-rotavirus agents, anti-Ebola virus agents, anti-Marburg virus agents, anti-Lassa virus agents, and combinations thereof. Suitable antimicrobial agents include, but are not limited to, anti-cholera agents, anti-E. coli agents, anti-tuberculosis agents, anti-leprosy agents, and combinations thereof.

Different agents, and different combinations of agents, can be combined in the same formulation, different formulations, or combinations thereof. This can be done for reason of convenience, such as having separate formulations for different agents for convenience in combining or mixing different agents in different formulations, or in order to increase or optimize the stability or form of the agents based on the composition of the formulation.

The formulations can also include probiotics, enzymes enhancing growth or weight gain such as phytases, proteases such as RONOZYME® ProAct, and carbohydrates. Many such products are widely used in animal feed formulations.

Different agents, and different combinations of agents, can be dispersed in the same particles, different particles, or combinations thereof. This can be done for reason of convenience, such as having separate particles for different agents for convenience in combining or mixing different agents in different formulations, or in order to increase or optimize the stability or form of the agents based on the composition of the particles.

Upon encapsulation by the pH-sensitive, thermally stable polymer, the agents should be stable to conditions encountered during storage, food preparation, and/or cooking.

In some forms, the amount of the micronutrient in the particles can be at least 0.1 μg per mg of particles (0.01%), at least 0.4 μg per mg of particles (0.04%), at least 1 μg per mg of particles (0.1%), at least 10 μg per mg of particles (1%), at least 50 μg per mg of particles (5%), at least 80 μg per mg of particles (8%), or at least 180 μg per mg of particles (18%).

B. Stabilizing Materials
Starch

It has been discovered that spray drying fat soluble-pH sensitive polymers into a starch type material prevents agglomeration and maintains particulate size and shape. The preferred material is a food grade starch.
Hyaluronic Acid and Vitamin C

Two materials have been found to stabilize iron supplements, preventing oxidation: hyaluronic acid or a derivative thereof, and vitamin C In some forms, these are added in a preferred ratio of between 1:4 and 1:10 iron:hyaluronic acid. In some forms, the iron supplement is encapsulated by microparticles formed of hyaluronic acid.
Matrix Polymers for Water Soluble Micronutrients

One or more biocompatible hydrophilic or amphiphilic polymers can be also used as a matrix to encapsulate water soluble micronutrients, such as vitamin B9 and B12. Preferably, the matrix polymer is water soluble. Suitable matrix polymers include, but are not limited to, polysaccharides such as hyaluronic acid or a derivative thereof, collagens, and hydrolyzed collagens such as gelatin. Microparticles of the matrix polymer can be generated to encapsulate the water soluble micronutrient. Such microparticles can be further coated or encapsulated by one or more pH-sensitive, thermally stable biocompatible polymer.
C. pH-Sensitive, Thermally Stable Polymers

The micronutrients are coated or encapsulated with one or more pH-sensitive, thermally stable biocompatible polymers. In some forms, the micronutrients are dispersed in a first matrix (such as those formed by hyaluronic acid or gelatin) to formed microparticles; such microparticles are further coated or encapsulated by a second matrix formed by one or more pH-sensitive, thermally stable biocompatible polymers. The solubility of the polymer is pH-dependent such that a desired release point in the gastrointestinal tract can be achieved by selecting the appropriate polymer. For example, if release is desired in the stomach, the pH-sensitive polymer ideally dissolves at a pH less than 3, preferably less than 2, such as 1-2. In other embodiments, release may be desired in the small intestine, wherein the polymer dissolves at the pH of the duodenum (pH 6-6.5) or the small intestine, such as 6-8, more preferably 7-8. For agricultural applications, such as mineral supplements to ruminants like cattle, sheep and goats, pH release between 5 and 6 is desirable to achieve release within the rumen.

The polymer is thermally stable. Preferred polymers are thermally stable during cooking, so that the formulation can be added to food like regular salt. Typically, food is prepared by boiling or simmering for 10 minutes to hours, cooking in a pot or pan over a fire, or baking in an oven for 15 minutes to an hour. The formulations will typically be designed for the most common cooking conditions in the geographic region in which the salt formulation is to be distributed.

The polymer is preferably water-insoluble when the pH is beyond the trigger pH range so that the polymer coating does not dissolve when in contact with moisture or water or an aqueous solution before oral administration, such as during storage or cooking. The polymer coating should remain sufficiently intact, e.g., up to or at least about one hour, such that the encapsulated agents are not released and/or denatured. The polymer is sufficiently non-porous such that water or other aqueous media cannot diffuse through the polymer and dissolve the materials in the core. The non-porosity may also serve to stabilize the materials in the core by preventing oxidation of air-sensitive materials. The material should remain non-porous under storage conditions for a period of weeks to months and for at least about 20 minutes to about 4 hours, preferably for at least about 20 minutes to about 2 hours, more for at least about 20 minutes to about 1 hour under food preparation and/or cooking conditions.

Exemplary polymers include polymethacrylates and derivatives thereof, such as ethyl methacrylate-methacrylic acid copolymer and those sold under the tradename EUDRAGIT®, naturally occurring cellulosic polymers (e.g., cellulose acetate succinate, hydroxy propyl methyl cellulose phthalate, and hydroxy propyl methyl cellulose acetate succinate) and other polysaccharides (e.g., sodium alignate, pectin, chitosan) or semi-synthetic or synthetic derivatives thereof, poly(2-vinylpyridine-co-styrene), polyvinyl acetate phthalate, shellac, fatty acids (e.g., stearic acid), waxes, plastics, and plant fibers.

In some embodiments, the one or more polymers is a polymethacrylate or a derivative thereof, such as those sold under the tradename EUDRAGIT®. In some embodiments, the polymer dissolves at a pH less than 6, preferably less than 5, 4, or 3, such as 1-3, or 1-2. Such polymers typically have functional groups, which are protonated at low pH, such as amines, which increase the solubility in aqueous media due to the formation of charged groups. Examples of such polymers include, but are not limited to, polymethacrylates or derivatives thereof such as EUDRAGIT® E PO (poly(butylmethacrylate-co-(2-dimethylaminoethyl)methacrylate-co-methylmethacrylate) (1:2:1); “EPO” or “BMC”), chitosan, and polymers which are cationic or become cationic under certain conditions (e.g., in vivo). In some forms, the polymethacrylate polymer has a structure as shown in Scheme 1, where x>0, y≥0, z≥0, n represents an integer, and the monomers are randomly distributed along the copolymer chain. In some forms, the ratio of x to y to z is about 2:1:1. In some forms, the average molecular weight of the polymethacrylate polymer is between about 10,000 Da and about 100,000 Da, between about 20,000 Da and about 80,000 Da, between about 40,000 Da and about 60,000 Da, or about 47,000 Da.

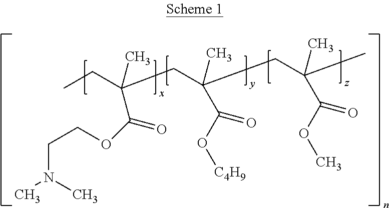

In other embodiments, the polymer is an enteric polymer which dissolves at a pH greater than the pH of the stomach, such as greater than pH 5-6. Such polymers typically have functional groups that form charged groups (e.g., carboxylic acids) at higher pH in order to increase solubility. In some embodiments, the polymer dissolves at a pH greater than about 5.5, such as EUDRAGIT® L 30 D-55 and L 100-55; greater than about 6.0, such as EUDRAGIT® L 100 and L 12,5; and greater than about 7.0, such as EUDRAGIT® S 100, S 12,5, and FS 30 D.

The thickness of the polymer coating or encapsulate can be varied in order to achieve the desires release rate. In some embodiments, the thickness of the coating is from about 1 Angstrom to hundreds of microns. In some embodiments, the thickness of the coating is from about 5 to about 200 microns, preferably from about 10 to about 100 microns, more preferably from about 10 microns to about 75 microns, most preferably from about 20 microns to about 50 microns.

D. Salt Coatings and Other Coatings

The particles encapsulating one or more micronutrients can be coated with salt, sugar, or other coating material, preferably salt, preferably salts that are suitable for consumption by an animal, such as a human. Exemplary salts include, but are not limited to, sodium and/or potassium chloride, magnesium chloride, potassium iodide, phosphates, and combinations thereof. In some embodiments, the thickness of the coating is from about 1 Angstrom to hundreds of microns. In some embodiments, the thickness of the coating is from about 5 to about 200 microns, preferably from about 10 to about 100 microns, more preferably from about 10 microns to about 75 microns, most preferably from about 20 microns to about 50 microns. Salts may be purified or impure, such as salt obtained by evaporation of salt or brackish water. The concentration of the salt can be from about 10% to about 80% by weight of the particle, preferably from about 10% to about 70%, more preferably from about 20% to about 60%, most preferably from about 40% to about 60%.

Other coating materials include sugar and other food components suitable as a coating. Preferred coating material can be compatible with and/or can help make the formulations compatible with food and products and components to be included in food (such as during food preparation or cooking).

Compositions serving as binders may be used to facilitate coating the particles with salts, sugar, or other coating material. The binders are used to bind the salt crystals to each other and to the surface of the particles. Exemplary compositions used as binders include, but are not limited to, starch such as wheat starch, corn starch, and potato starch, polyvinyl alcohol (PVA), carboxymethyl cellulose, and methyl cellulose.

### III. Methods of Making

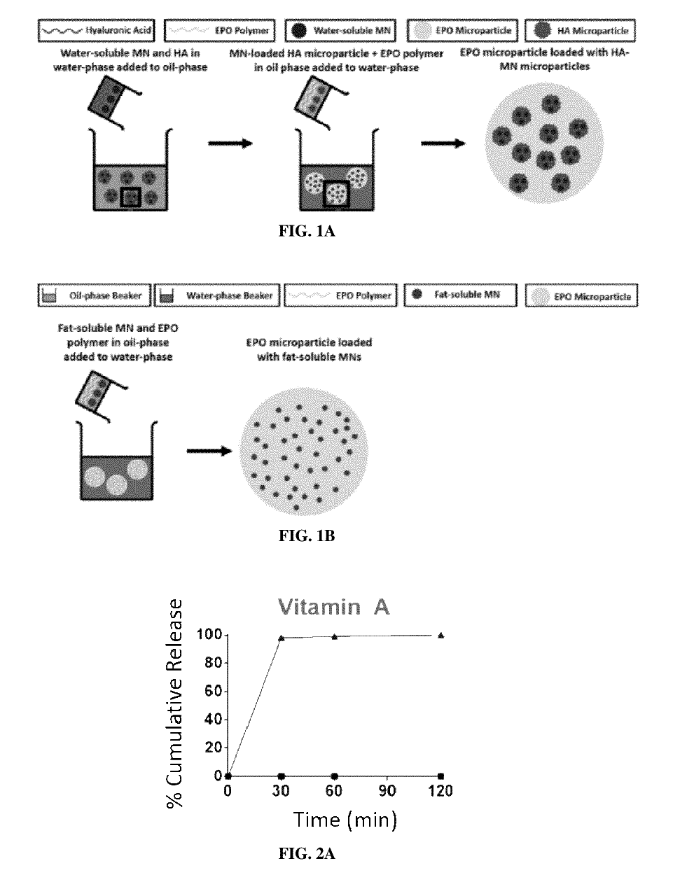

The process for encapsulating water soluble micronutrients into a pH sensitive polymeric material is shown in FIG. 1A (i.e., two-step method). The process for encapsulating fat soluble micronutrients into a pH sensitive material is shown in FIG. 1B (i.e., one-step method). These processes are described in more detail in the examples.

A. Methods for Encapsulation of Micronutrients

Common microencapsulation techniques to generate microparticles encapsulating one or more micronutrients include, but are not limited to spray drying, interfacial polymerization, hot melt encapsulation, phase separation encapsulation (spontaneous emulsion microencapsulation, solvent evaporation microencapsulation, and solvent removal microencapsulation), coacervation, low temperature casting, phase inversion nanoencapsulation, and centrifugal atomization (such as spinning disc atomization).

In some forms, the HA-based microparticles are formed by solvent removal microencapsulation or spray drying.

In some forms, the pH sensitive polymer-based microparticles are formed by phase inversion nanoencapsulation or spinning disc atomization.

Exemplary methods of generating microparticles encapsulating one or more micronutrients are briefly described below.
1. Spray Drying

Microparticles encapsulating one or more micronutrients can be generated by spray-drying techniques as described in U.S. Pat. No. 6,620,617 to Mathiowitz et al. In this method, a microparticle-forming compound (also referred to as “encapsulant”, “particle-forming compound”, or “particle-forming polymer”) is dissolved in a solvent system such as an aqueous medium (e.g., water), an organic medium (such as methylene chloride), or a mixed solvent medium (such as a mixture of water and tert-butyl alcohol). A known amount of one or more micronutrients to be incorporated in the microparticles is suspended (in the case of an insoluble micronutrient) or co-dissolved (in the case of a soluble micronutrient) in the aforementioned solvent system. Preferably, the micronutrient is co-dissolved in the solvent system. The solution or dispersion is pumped through a micronizing nozzle driven by a flow of compressed gas, and the resulting aerosol is suspended in a heated cyclone of air, allowing the solvent to evaporate from the microdroplets, forming particles.

Microspheres/nanospheres ranging between 0.1-10 microns can be obtained using this method. Preferably the particles formed by this method range from about 1 to about 10 μm in size.

In some forms, the HA-based microparticles, such as the HA-Fe microparticles are formed using this method. For example, an aqueous solution containing an iron supplement (such as ferrous sulfate, anhydrous or hydrous), HA or a derivative thereof (such as sodium hyaluronate), and optionally one or more water soluble micronutrients can be fed into a spray dryer to generate HA-Fe microparticles.
2. Centrifugal Atomization

In centrifugal atomization (also referred to as “rotary atomization”), a nozzle introduces fluid at the center of a spinning cup or disk. Centrifugal force carries the fluid to the edge of the disk and throws the fluid off the edge. The liquid forms ligaments or sheets that break into fine droplets. The fine droplets can be solidified to form microparticles via exposure to air and/or a pharmaceutical excipient such as powdered starch. Methods of centrifugal atomization, especially spinning disc atomization, are described, for example, in U.S. Pat. No. 4,675,140 to Sparks and Mason and PCT Patent Application No. WO 2012/075309. In some forms, the pH sensitive polymer-based microparticles are formed by centrifugal atomization such as spinning disc atomization. For example, a pH sensitive polymer is first dissolved in an organic solvent such as methylene chloride. One or more micronutrients to be incorporated, such as fat soluble vitamins, HA-Fe microparticles, and microparticles containing one or more water soluble micronutrients, are mixed or dissolved in the polymer solution, in the presence of a surface active agent such as Tween 80. The obtained emulsion is then introduced to a spinning disk atomizer under conditions to produce the pH sensitive polymer-based microparticles, which encapsulates the micronutrient.

B. Encapsulation of Iron Supplements

The iron particles containing iron supplement can be prepared using techniques known in the art such as milling The iron supplement, preferably ferrous sulfate (FeSO₄), or iron particles of the iron supplement are mixed with a material such as hyaluronic acid or a derivative thereof, preferably in a ratio of between about 1:4 to 1:10, iron:HA, or with vitamin C, and/or encapsulated with enteric polymer to prevent oxidation of the iron supplement. The mixture is then dispersed into a solution of a pH sensitive polymer, preferably a EUDRAGIT®, most preferably EPO. In preferred forms, the solvent for the solution of the pH sensitive polymer is an organic solvent, such as methylene chloride. The pH sensitive polymer-based microparticles encapsulating the iron supplement are generated by microencapsulation techniques such as spray drying, and spinning disc atomization under conditions producing particles between one micron and one mm, most preferably averaging 150 microns.

In some forms, the iron supplement can be encapsulated into microparticles via a two-step method as illustrated in FIG. 1A. For example, the iron supplement is first encapsulated in microparticles formed by HA or a derivative thereof. In some forms, the Fe-HA microparticles are formed by dissolving the iron supplement such as ferrous sulfate into an aqueous medium such as water, together with HA or a derivative thereof such as sodium hyaluronate, followed by microencapsulation using techniques such as spray drying and solvent removal microencapsulation. The obtained Fe-HA microparticles are further coated or encapsulated by a pH sensitive polymer, preferably EUDRAGIT®, most preferably EPO. In some forms, other water soluble micronutrients, including water soluble vitamins and trace minerals, can be encapsulated together with the iron supplement. For example, such micronutrients can be co-dissolved with the iron supplement during the production of Fe-HA microparticles.

C. Encapsulation of Fat Soluble Micronutrients

Fat soluble micronutrients such as fat soluble vitamins can be encapsulated into microparticles via a one-step method as illustrated in FIG. 1B.

One or more fat soluble vitamins such as vitamin A, D, and E are encapsulated into pH sensitive polymeric particles by dissolving or dispersing the vitamin into a solution of a pH sensitive polymer, preferably a EUDRAGIT®, most preferably EPO, followed by microencapsulation such as by spray drying or spin disking into a starch powder (other pharmaceutical excipients equivalent to starch are known and available). The starch prevents agglomeration of the particles after microencapsulation and to maintain particle shape.

In preferred forms, the solvent for the solution of the pH sensitive polymer is an organic solvent such as methylene chloride.

D. Encapsulation of Water Soluble Micronutrients

Water soluble micronutrients such as water soluble vitamins and trace minerals can be encapsulated into microparticles via a two-step method as illustrated in FIG. 1A.

One or more water soluble micronutrients are first encapsulated in microparticles formed by a hydrophilic or amphiphilic matrix polymer such as HA, gelatin, and derivatives thereof (first step). The microparticles may be formed by dissolving the water soluble micronutrient in an aqueous medium such as water, together with the matrix polymer, followed by microencapsulation using techniques such as spray drying and solvent removal microencapsulation. The obtained microparticles are further coated or encapsulated by a pH sensitive polymer, preferably EUDRAGIT®, most preferably EPO, to yield the final microparticles (second step). In some forms, the final microparticles are formed by dispersing the microparticles from the first step into a solution of the pH sensitive polymer, preferably a EUDRAGIT®, most preferably EPO. In preferred forms, the solvent for the solution of the pH sensitive polymer is an organic solvent, such as methylene chloride. The pH sensitive polymer-based microparticles can be generated by microencapsulation techniques such as phase inversion nanoencapsulation, spray drying, and spinning disc atomization.

E. Co-Encapsulation of Water Soluble and Fat Soluble Micronutrients

Co-encapsulation of water soluble and fat soluble micronutrients can be performed using a two-step process similar to that illustrated in FIG. 1A. One or more water soluble micronutrients such as water soluble vitamins and trace minerals are first encapsulated in microparticles formed by a hydrophilic or amphiphilic matrix polymer such as HA, gelatin, and derivative thereof (first step). When the water soluble micronutrient is or contain an iron supplement such as ferrous sulfate, vitamin C can be included to avoid oxidation of the iron supplement; alternatively, HA or a derivative thereof can be used as the matrix polymer to form the microparticles.

In the second step, the microparticles encapsulating the water soluble micronutrient from the first step are dispersed in a solution containing a pH sensitive polymer, preferably EUDRAGIT®, most preferably EPO. In preferred forms, the solvent for the solution of the pH sensitive polymer is an organic solvent such as methylene chloride. Fat soluble micronutrients, such as fat soluble vitamins, are then added to the polymer solution prior to or after the addition of the microparticles from the first step. The pH sensitive polymer-based microparticles encapsulating both the water soluble and fat soluble micronutrients can be generated by microencapsulation techniques such as phase inversion nanoencapsulation, spray drying, and spinning disc atomization.

F. Extrusion and/or Milling

In some forms, coating or encapsulation of one or more micronutrients can be achieved using extrusion, optionally followed by milling. Extrusion is a solvent-free/non-aqueous process. Compared to spray drying, this method can achieve high-throughput and have better availability. Extrusion can generate solid fibers, which can be subsequently milled to obtain powdered product.

In some forms, one or more micronutrients, in either solid or liquid form, is mixed with EPO. Lyophilization of the mixture can be performed to remove solvent. Milling of the resulting solid mixture can be performed to obtain uniform powder, which can be further lyophilized to dryness. The uniform powder is loaded into an extrusion machine, optionally under heating conditions such as between about 80 and about 150° C., between about 90 and about 120° C., or between 100 to about 105° C. The extruded fiber can be further milled to generate a micronutrient-containing powder, which can be lypophilized to dryness.

The milling processes can be performed under a wide variety of conditions to generate micronutrient-containing powder with different physical properties. For example, the milling processes can be performed at room temperature or cryo temperatures. The milling processes can be performed via Fitz milling or jet milling.

Dying aid can be added before, during, or after the final milling step to improve storage stability, i.e., avoid caking.

G. Pharmacokinetics and Stability

The micronutrient is encapsulated in the pH-responsive polymer using microencapsulation techniques such as spray drying and spin disk atomization. The release kinetics of the micronutrient in the particles is dependent on a variety of factors, such as the pH at which the polymer dissolved and the coating thickness. In some embodiments, the thickness of the coating is from about 1 Angstrom to hundreds of microns. In some embodiments, the thickness of the coating is from about 5 to about 200 microns, preferably from about 10 to about 100 microns, more preferably from about 10 microns to about 75 microns, most preferably from about 20 microns to about 50 microns.

The activity and stability of the particles can be evaluated using techniques known in the art such as ELISA, colorimetric assay, elemental analysis, mass spectroscopy, and/or HPLC. Combinatorial nutrient encapsulation studies can be conducted to determine if any of the agents in the particles react adversely with each other.

In the preferred embodiment, the particles are tested for stability under conditions equivalent to cooking (such as boiling for two hours at 100° C. in water) and/or to long term storage (at least 60 days) under conditions of high humidity (75%) and heat (40° C.). Vitamins and other bioactive compounds should retain at least 50, 60, 70, 80, 90 or 100% of the starting bioactivity (i.e., bioactivity prior to particle formation).

In some forms, the particles releases >80% of the micronutrient payload within two hours, within one hour, or within 30 min at 37° C. in simulated gastric fluid at pH 1.5. In some forms, the particles releases >90% of the micronutrient payload within two hours, within one hour, or within 30 min at 37° C. in simulated gastric fluid at pH 1.5. In some forms, the particle release >95% of the micronutrient payload within two hours, within one hour, or within 30 min in at 37° C. in simulated gastric fluid at pH 1.5.

In some forms, the particles retains >80% of the micronutrient payload after exposure to 100° C. water for two hours. In some forms, the particles retains >85% of the micronutrient payload after exposure to 100° C. water for two hours. In some forms, the particles retains >90% of the micronutrient payload after exposure to 100° C. water for two hours.

In some forms, the particles stabilize the encapsulated micronutrient payload. The criteria for stability of an iron-containing micronutrient formulation is that the iron supplement does not oxidize to the point where it loses more than 50%, 60%, 70%, 80%, 90% or 100% of its bioactivity after exposed to boiling water for two hours or subjected to long term (e.g., from 14 to 60 days, such as 14, 28, and 60 days) exposure to high humidity (e.g., 60-75%, such as 75%) at storage temperature (e.g., -4-40° C., such as 40° C.), as compared to the bioactivity when encapsulated. The criteria for stability of a vitamin-containing micronutrient formulation is that the vitamin does not lose more than 50%, 60%, 70%, 80%, 90% or 100% of its bioactivity after exposed to boiling water for two hours or subjected to long term (e.g., from 14 to 60 days, such as 14, 28, and 60 days) exposure to high humidity (e.g., 60-75%, such as 75%) at storage temperature (e.g., -4-40° C., such as 40° C.), as compared to the bioactivity when encapsulated.

H. Salt Coating

The microparticles encapsulating one or more micronutrients can be coated with one or more salts (or other coating material) using techniques known in the art. A preferred method uses a fluidized bed. Other suitable techniques include crystallization of the salt on the polymer jacket and wet and dry salt fabrication techniques. The diameter of the final salt-coated particles can vary but it typically from about 500 microns to about 1000 microns (1 mm).

### IV. Methods of Use

The formulations, such as fortified salt formulations, can be packaged and distributed for use during food preparation and cooking. The formulations may be used without salt coating (or other coatings) to fortify flour and other foods. The formulations can withstand liquid and solid sterilization, which is useful for beverage, liquid food, or solid food preparation.

The formulations can be used to treat or prevent malnutrition and/or micronutrient deficiency, particularly in populations susceptible to such maladies, such as children and adults in developing countries and countries suffering from severe drought. The formulations can be incorporated in food vehicles for use by the populations in need. Because of high variability in commonly consumed food vehicles by the populations in need, the formulations can be used with and incorporated into a variety of food vehicles, including wheat flour, cooking oil, sugar, and salt.

In some embodiments, the particles contain one or more of the essential micronutrients including vitamins A, B1, B2, B3, B6, B7, B9, B12, C, D, and E; molybdenum, chromium, selenium, iodine, copper, manganese, zinc, and iron. The amount of the micronutrients incorporated into the particles can be based on the RDA for a particular micronutrient. For example, the amount of micronutrients can be based on 50%, 60%, 70%, 80%, 90%, or 100% RDA.

In some embodiments, the formulation is used for universal fortification where the target population is the general population including healthy individuals. The formulation can contains up to 100% RDA for iodine and less than or equal to 50% RDA for all other micronutrients. In other embodiments, the formulation is used for targeted fortification where the target population is micronutrient deficient households. The formulation can contain, for example, up to 100% RDA for children 6-59 months old.

In particular embodiments, 2 g/day of the formulation can provide up to 100% RDA for children for the micronutrients iodine (0.09 mg/day), zinc (4.1 mg/day), folic acid (0.15 mg/day), vitamin B12 (0.0009 mg/day), vitamin A (0.4 mg/day), vitamin C (30 mg/day), vitamin D (0.005 mg/day), and/or iron (10 mg/day).

In other embodiments, 5 g/day of the formulation can provide up to 50% RDA for adult woman for the micronutrients iodine (0.075 mg/day), zinc (8 mg/day), folic acid (0.2 mg/day), vitamin B12 (0.0012 mg/day), vitamin A (0.45 mg/day), vitamin C (37.5 mg/day), vitamin D (0.0075 mg/day), and/or iron (9 mg/day).

In other embodiments, the formulations can be used in a variety of foods and staples. For example, the formulations can constitute or be included in food ingredients such as salt, sugar, oil, flour, baking soda, baking powder, starch (such as corn starch), butter, shortening, meal (such as corn or other grain meal), coffee, tea, spices, flavorings, extracts, etc. Examples of foods in which the formulations can be incorporated include beverages, such as milk, water, soda and other carbonated beverages, sports drinks, juice, baked goods such as breads, cakes, cookies, and pies, processed foods such as yogurt, cheese, and nutrition or energy bars.

In other embodiments, the formulations are used for agricultural purposes, such as being incorporated in feedstock. Minerals and salt are essential for animal health, and it is difficult for these formulations to maintain integrity under adverse climatic conditions and in storage. These formulations are weather resistant and stable in storage in heat and high humidity. Advantages to the pH-dependent release are that formulations can be designed to provide maximum release in the region of the gastrointestinal tract where uptake is most effective, such as the rumen. Additional benefits are obtained through the incorporation of vitamins and medicines such as deworming agents which otherwise would have to be administered separately.

The present invention will be further understood by reference to the following non-limiting examples.

A pH-responsive microparticle (“MP”) capable of protecting encapsulated MN payloads during storage and cooking conditions was developed. The MN-MPs were designed for controlled payload release via rapid solubilization in the gastrointestinal tract such as stomach conditions to facilitate downstream MN absorption in the intestines.

Co-encapsulation, protection, and release of multiple MNs of distinct physical and chemical properties (i.e. both fat- and water-soluble MNs) in a single particle for combination-fortification was achieved, such as for vitamins A, D, B9, and B12. This lab-scale technology was then used to encapsulate iron and its absorption in humans Iron deficiency represents the most devastating nutritional deficiency worldwide, affecting populations in both the developed and the developing world. For example, iron deficiency is particularly destructive in the developing world, as sufficient iron intake is critical for the development (e.g. behavior, cognition and psychomotor skills) of infants and small children. Iron deficiency also impacts the developed world, as patients afflicted with chronic kidney diseases frequently suffer from iron-deficiency anemia. As such, significant efforts to address iron-deficiency in both the developed- and the developing

This MN-MP-technology has been translated from the lab to the clinic in human trials, and from lab-scale to industrially-relevant processes for the synthesis of greater than 1 kg batches for the non-invasive delivery of iron.

The clinical and commercial translation of therapeutic technologies are often limited by challenges arising from tests at the lab-level (e.g. in vitro and in vivo), the clinical level (e.g. clinical studies in humans), and at the commercial/industrial level (e.g. translation of lab-scale synthesis approaches to industrial-scale). The MN-MP delivery system was developed using lab-scale emulsion processes and shown to simultaneously encapsulate both water-soluble and fat-soluble MNs, prevent leakage of the MN payload, provide controlled and pH-responsive release, and maintain the chemical and biological stability of the encapsulated MNs under cooking conditions (100° C. in water). In vivo, the controlled and site-specific payload release in the stomach to facilitate payload-intestine interactions was confirmed. The lab-synthesized iron-loaded HA-EPO-MPs were investigated in a clinical trial absorption study in humans where the MPs showed efficacy in delivering iron through oral delivery via a meal. Following the clinical trial, the particle synthesis from a lab-scale emulsion processes was successfully translated to industrially-relevant processes such as spray drying and spinning disk atomization methods. The iron HA-EPO-MPs synthesized from spray drying and spinning disk atomization exhibited similar performance to the lab-scale.

The MN-delivery platform can also be used for the co-delivery of multiple MNs, based on the successful encapsulation, release, and MN-protective behavior through co-encapsulation of four separate vitamins: (i) fat-soluble vitamin A, (ii) fat-soluble vitamin D, (iii) water-soluble vitamin B9, and (iv) water-soluble vitamin B12. Vitamin A was selected as it regulates critical physiological processes in the human body, including many involved in morphogenesis, growth, maturation, vision, reproduction, and immunity. Vitamin D, often described as “hormone-like”, was selected since it is essential in the maintenance of healthy bones, increasing calcium and phosphorous absorption, and improving mineral resorption into bone tissues. Vitamin B9 mediates the formation of circulatory red and white blood cells in the bone marrow and acts as a carrier in the formation of heme. Vitamin B12 μlays a critical role in the synthesis and repair of DNA and has a vital influence on neurologic function.

Collectively, the worldwide deficiencies of these MNs occur in an estimated 2 billion people; their fortification remains an unmet worldwide need. Furthermore, individuals suffering from a single MN deficiency often suffer from at least one-to-five other MN deficiencies. As such, delivery approaches capable of delivering multiple MNs in a single formulation have the potential to make significant impact.

The limited leakage of MN payloads observed at both room temperature and boiling water for the co-encapsulated MN formulation indicates that the interactions between the co-encapsulated vitamins and other chemically reactive compounds involved in cooking are prevented. Degradation of the two fat-soluble MNs, vitamins A and D, under various conditions has been well studied and reported. Vitamin A contains five conjugated double bonds, and thus it is susceptible to oxidation at high temperatures and during exposure to light. Oxidation of vitamin A decreases its bioavailability and also leads to unpleasant tastes. Vitamin D, which was co-encapsulated alongside vitamins A, B9, and B12, is also unstable at high temperatures and when exposed to light which leads to lower bioavailability upon ingestion. The study showed that the recovery of both encapsulated vitamin A and D after heat treatment and light exposure was significantly higher than that of equivalent amount of non-encapsulated vitamin A and D under identical conditions. For the co-encapsulated water-soluble vitamins, B9 and B12, no degradation under cooking conditions was reported in either the encapsulated or non-encapsulated forms. These results are in agreement with previously reported studies, which showed that both vitamins B9 and B12 are thermally stable. Overall, the MP-delivery system effectively maintained the stability of water-soluble MNs under the simulated cooking conditions and increased cooking stability and protection against light in the case of the fat-soluble MNs.

Similar stability results were shown for single iron HA-EPO-MP encapsulation; specifically, higher retention of bioavailable ferrous iron was exhibited for the HA-EPO-MPs after boiling for 2 hours in water. Furthermore, interactions with polyphenols in banana milk, that negatively change the food's color, were significantly reduced as a result of HA-EPO-MP encapsulation. In summary, encapsulation of iron in HA-EPO-MPs dramatically improved the stability of the encapsulated iron and also prevented interactions between iron and other molecules present in food. In addition to limiting premature payload leakage and heat-mediated MN degradation, rapid release of iron in the acidic gastric environment is a key requirement. This is because iron absorption occurs almost exclusively in the duodenum in the small intestines, which is a short segment (25-38 cm) connecting the stomach to the jejunum. Thus, if the iron is released in the duodenum, limited amounts will be absorbed given the short length and the rapid transit time of food in the duodenum. As such, rapid and controlled release of the payload within the stomach is critical. In the study, the rapid release of iron was exhibited pre- and post-cooking (2 hours boiling in water) in vitro.

This was also investigated in vivo in mice, where the dissolution of particles in the stomach occurred rapidly (<60 min) and the released payload predominantly interacted with the small intestines. Overall, the MPs were expected to efficiently release the cargo in the stomach, which could translate into optimal absorption in efficacy studies. The efficacy of the iron-loaded HA-EPO-MPs to deliver iron in humans was tested to demonstrate this.

The HA-EPO-MP technology exhibited significantly lower relative bioavailability (RBV) as compared to of non-encapsulated iron. This lower RBV of the HA-EPO-MP iron, which was ˜45% of the non-encapsulated iron, suggests the encapsulation has an inhibitory effect on iron absorption. It is well known that polymeric encapsulation of iron can inhibit its absorption by approximately 20% when a polymer:iron ratio of 60:40 is used. In this study, the polymer:iron ratio was dramatically higher (99.5:0.5). The microencapsulated iron formulation showed no statistical differences in cooked and uncooked conditions, indicating that the EPO-matrix protects the encapsulated iron during cooking.

### EXAMPLES

### Example 1

### pH-Responsive MP Capable of Protecting Encapsulated MN Payloads During Storage and Cooking Conditions

Materials and Methods

This study was to develop a MP-based MN delivery system that can improve the stability of MNs during cooking and simultaneously control payload release in the gastric stomach environment. The release profile and the thermal-stability of the MNs were studied in vitro; the dissolution of the polymeric MPs was investigated in mice; and finally the absorption of iron-fortified particles was evaluated in human subjects. Animal studies were approved by the Massachusetts Institute of Technology (MIT) Committee on Animal Care and were performed at the David H. Koch Institute for Integrative Cancer Research. Clinical studies involving human subjects were approved by both the Committee on the Use of Humans as Experimental Subjects at MIT (Human study 1: COUHES # 1502006932; Human study 2: COUHES #1801201448/1801201448A001) and the Ethics Commission of ETH Zurich, and were performed at ETH Zurich (Human study 1: KEK-ZH-Nr. 2015-0094; Human study 2: KEK-ZH-Nr. 2017-01624). All human subjects were provided with informed consent. These studies were registered on ClinicalTrials.gov under Identifier NCT02353325 for human study 1 and NCT03332602 for human study 2. Particles used in human study 1 were produced at MIT and those used in human study 2 were produced at Southwest Research Institute (SwRI) in San Antonio, Tex.

Formulation of HA-MPs

HA-MPs were formulated using a modified inverse emulsion technique (Jha, et al., Controlling the adhesion and differentiation of mesenchymal stem cells using hyaluronic acid-based, doubly crosslinked networks. Biomaterials 32, 2466-2478 (2011)). Although described with respect to specific polymers, solvents and surfactants, and micronutrients, it is understood that these are representative of other materials that could be used with only routine optimization.

Briefly, the emulsion of blank HA-MPs were prepared by homogenizing HA solution (low molecular weight HA, Mn=384 kDa, Mw=803 kDa, Lifecore Biomedical; 1 wt % in 2 ml of de-ionized water) in mineral oil (30 ml) containing 120 μl of SPAN®80 for 10 min using a Silverson L5M-A laboratory mixer (Silverson Machines, Inc.). To prepare the MN encapsulated HA-MPs, vitamins B9, B12 and ferrous sulfate heptahydrate were dissolved in the HA aqueous solution (1 wt % in 2 ml of de-ionized water) with a concentration of 5 mg/ml, 5 mg/ml and 73.8 mg/ml, respectively. The resulting solution was then used for the preparation of the emulsion as described above.

The aqueous phase of the emulsion was allowed to evaporate for 24 hours at 45° C. with constant stirring. The obtained HA-MPs were then isolated by centrifugation at 3000 rpm for 5 min The HA-MPs were thoroughly washed by hexane and acetone before drying under vacuum overnight. To prepare fluorescently labeled HA-MPs, HA derivatives containing aldehyde groups (HA-CHO) were first synthesized using sodium periodate following reported procedures (Jia, et al, Hyaluronic acid-based microgels and microgel networks for vocal fold regeneration. Biomacromolecules 7, 3336-3344 (2006). Since oxidation causes chain cleavage of the HA, high molecular weight HA (Mn=1096 kDa, Mw=2698 kDa, Lifecore Biomedical) was used. The molecular weight of obtained HA-CHO was analyzed by gel permeation chromatography (GPC). The degree of modification was quantified as 65% by an iodometry method (Jha, et al., Structural Analysis and Mechanical Characterization of Hyaluronic Acid-Based Doubly Cross-Linked Networks. Macromolecules 42, 537-546 (2009)).

To formulate fluorescent HA-MPs, HA-CHO and unmodified HA were mixed with a weight ratio of (1:1) and were then used to prepare the MPs by the inverse emulsion method as described above. For dye labelling, one milligram of the HA-MP containing aldehyde groups was dispersed in a methanol solution of CF™ 405M (fluorescent dye containing aminooxy group, Biotium Inc.). Acetic acid (5 ul) was added to accelerate the reaction. The reaction was then allowed to proceed for 12 hours at room temperature. The dye labelled particles were collected by centrifugation (3000 rpm, 5 min), and thoroughly washed using methanol before drying under vacuum.

Formulation of EPO-MPs and HA-EPO-MPs

EPO-MPs were prepared by a modified O/W emulsion method (Kemala, et al., Arabian Journal of Chemistry 5, 103-108 (2012)). Micronutrients were encapsulated individually in EPO-MPs using a one-step (FIG. 1A) or two-step (FIG. 1B) emulsion process. Although described with respect to specific polymers, solvents and surfactants, and micronutrients, it is understood that these are representative of other materials that could be used with only routine optimization.

The organic phase for the emulsion consisted of either: (a) one milligram of blank, or dye labelled HA MPs homogeneously dispersed in 1 ml of 100 mg/ml EUDRAGIT® EPO (Mₙ=153 kDa, Mw=24981 kDa, and glass transition temperature =45° C., Evonik Corporation) solution in methylene chloride; (b) vitamin A (10 mg/ml), vitamin D (2 mg/ml), folic acid-loaded HA MPs (1.3 mg), and B12-loaded HA MPs (1.3 mg) dissolved into EPO solution (100 mg/ml, 1 ml) in methylene chloride to prepare EPO MPs co-encapsulated with four different types of micronutrients; (c) HA MPs or Ge MPs encapsulated with various micronutrients as described in Table 2 to synthesize HA-EPO MPs and Ge MPs with various micronutrient loads; (d), free micronutrients as described in Table 2 to synthesize EPO MPs with various micronutrient loads; or (e) 1 mg/ml lipophilic carbocyanine DiOC18(7) dye (DiR, Life Technologies) and 100 mg/ml EPO in methylene chloride to synthesize fluorescently labeled EPO MPs. The resulting organic phases were then emulsified in 20 ml, 10 mg/ml polyvinyl alcohol (PVA) solution with a stirring rate at 300 rpm for 10 min. The obtained emulsion was added into 100 ml de-ionized water with stirring (500 rpm for 10 min) to solidify the MPs. The obtained MPs were allowed to settle by gravity, and were thoroughly washed with water. The final dry MPs were obtained by lyophilization.

Notably, to prepare EPO-MPs co-encapsulated with four different MNs, vitamin A (10 mg/mi) and vitamin D (2 mg/ml) were directly dissolved into the EPO solution (100 mg/ml, 1 ml) in methylene chloride, and then B9-loaded HA-MPs (1.3 mg) and B12-loaded HA-MPs (1.3 mg) were dispersed into the solution above.

Morphological MP Characterization

Three different microscopic methods were used to characterize the MP size, morphology, and cross sections; namely, optical microscopy (Olympus MX40), scanning electron microscopy (JEOL 5910 SEM), and confocal microscopy (Zeiss LSM 700 Laser Scanning Confocal). Dry MPs were coated with Pt/Pd before SEM imaging. Dye labeled HA-MPs were visualized by the confocal microscope at an excitation wavelength at 405 nm, with a band pass filter of 420-475 nm. Reported mean particle diameters were estimated using ImageJ based on at least 20 counts of the particles from SEM images.

MN loading Content and Encapsulation Efficiency

Vitamins B2, B3 (niacin), B9 (folic acid), B12, A, and D were analyzed via HPLC (Agilent 1100; Agilent Technologies, Santa Clara, Calif.) using a C-18 column (Acclaim' PolarAdvantage II, 3 μm, 4.6×150 mm) and were detected by a photodiode detector at 265, 265, 286, 550, 325, and 264 nm, respectively. Iron, biotin, zinc, and vitamin C were analyzed via BioVision colorimetric assay kits and vitamin B7 (biotin) was analyzed via a Sigma colorimetric assay kit. Iodine was measured using UV-Vis absorbance at 288 nm.

Micronutrient-loaded HA MPs were dissolved in water, and micronutrient content was determined as described above for each respective micronutrient.

To quantify micronutrient loading in EPO MPs, a known mass of EPO MPs were first dissolved in SGF, and then 1 M sodium hydroxide (NaOH) solution was added to neutralize the pH. The precipitated EPO was removed via centrifugation using Amicon Ultra centrifuge filters (3000 NMWL) at 14000×g for 30 min, and the dissolved micronutrients in the supernatant were separated and quantified as described above.

To quantify vitamins A and D loading, the EPO MPs were dissolved in methylene chloride and the dissolved vitamins A and D were separated and quantified as described above.

Known amounts of DiR-loaded EPO-MPs were dissolved in DMSO, and then the dissolved cargo was quantified using a multimode reader (TECAN Infinite®M200 PRO) at 750 nm.

The loading content (LC) was defined as the amount of MN (μg) per mg of particles. The encapsulation efficiency (EE) was calculated by dividing the amount of MN loaded into the particles with the amount of MN initially added during the emulsion process.

In Vitro Release of MN

The release profiles of micronutrients from MPs were studied in three different environments:

(a) water at room temperature,

(b) boiling water at 100° C., and

(c) SGF (pH 1.2) at 37° C.

At predetermined time points, all samples were centrifuged at 4000 rpm for 5 min and 900 μl of the supernatant was collected for analysis, and then samples were replenished with 900 μl of fresh release medium. Specifically for vitamins A and D, the aqueous release medium was brought into contact with a layer of methylene chloride, then the extracted fat-soluble vitamins within the organic phase were used for analysis. The quantification methods for each MN are described above. The cumulative release was calculated as the total amount of MN released at a particular time point relative to the amount initially loaded.

MN Stability

Dry micronutrient-loaded MPs were dispersed in water and then heated at 100° C. for 2 hours before being centrifuged at 4000 rpm for 5 min. Chemically stable MNs in both the supernatant and the MPs were quantified using the methods as described above. The stability percentage equals to the ratio of stable MN after heating as determined by HPLC to the actual loading content of the MN in the MPs. For samples in non-encapsulated form, they were either dissolved in water (water soluble vitamins such as vitamins B9 and B12) or dispersed in water (fat soluble vitamins such as vitamins A and D) before being heated for 2 hrs. Iron-loaded HA-EPO-MPs were dispersed in water and then heated at 100° C. for 2 hours and analyzed for ferrous and ferric content as described above.

For banana milk experiments, the fortification concentration was 15 ppm of iron per food fresh weight, so that 100 g of edible portion would contain 1.5 mg Fe. Banana milk tests were performed at room temperature. Color measurements were taken at 0, 15, 30, 60, 120, and 1440 (24 h) minutes using a Minolta Chroma meter CR-300, Konica Minolta). The samples were stirred for the duration of 2 h at 200 rpm, and stored overnight at 4° C. The change in color is expressed in ΔE, which represents the absolute color difference, but not the direction of the color difference. FeSO₄ and ferric pyrophosphate (FePP, 20% Fe, micronized powder) were used as positive and negative controls.

Results

Particle Synthesis and Characterization

Separate emulsion-based encapsulation approaches for water-soluble (FIG. 1A) and fat-soluble MNs (FIG. 1B) were developed to address formulation challenges for physically- and chemically-distinct MNs. Polymer choice for the encapsulating matrix ultimately determines the performance and thus the potential impact of MP-fortificants. The outer matrix of the MPs consists of EUDRAGIT® EPO, a food grade and pH-responsive methacrylate-based copolymer that facilitates rapid degradation and subsequent payload release in acidic gastric conditions. MP degradation in acidic conditions is essential to achieve payload release in the stomach, so as to ensure adequate intestinal absorption. MP stability in neutral conditions is an often overlooked fortificant requirement that, if achieved, will prevent premature payload release in cooking conditions (e.g. in boiling water) that can lead to MN degradation and thus minimize fortification-driven health benefits.

Formulation parameters and loadings for each of the lab-scale MPs encapsulating individual MNs are shown in Table 2.

TABLE 2
Formulation parameters and loadings for lab-scale MPs.
EPO-MPs

| | | EPO | Loading |
|---|---|---|---|
| MN | MN (mg) | (mg) | (μg/mg) |
| Vitamin A | 10 | 100 | 73 ± 7 |
| Vitamin B2 | 15 | 200 | 67 ± 2 |
| Vitamin C | 20 | 200 | 63 ± 2 |
| Vitamin D | 2 | 100 | 12 ± 1 |
| Zinc | 17 | 100 | 11 ± 1 |
| Iodine | 5 | 100 | 21 ± 3 |

HA-MPs and HA-EPO-MPs

| | HA-MPs | | | HA-EPO-MPs | | |
|---|---|---|---|---|---|---|
| | MN | HA | Loading | HA-MN | EPO | Loading |
| MN | (mg) | (mg) | (μg/mg) | (mg) | (mg) | (μg/mg) |
| Fe | 30 | 20 | 185 ± 5 | 11.3 | 200 | 6.0 ± 0.1 |
| Folic acid | 5 | 20 | 117 ± 21 | 5.2 | 100 | 1.7 ± 0.1 |
| Vitamin | 5 | 20 | 141 ± 17 | 2.5 | 100 | 2.3 ± 0.1 |
| B12 | | | | | | |

Ge-MPs and Ge-EPO-MPs

| | Ge-MPs | | | Ge-EPO-MPs | | |
|---|---|---|---|---|---|---|
| | MN | Ge | Loading | Ge-MN | EPO | |
| MN | (mg) | (mg) | (μg/mg) | (mg) | (mg) | Loading (μg/mg) |
| Niacin | 15 | 20 | 58 ± 5 | 5 | 200 | 0.4 ± 0.1 |
| Biotin | 17 | 20 | 320 ± 5 | 3 | 200 | 3.5 ± 0.6 |

For encapsulation of water-soluble MNs, a two-step emulsion process (FIG. 1A) was used where first a water-in-oil (W/O) emulsion step was used to encapsulate water-soluble MNs in hyaluronic acid (HA)-MPs (HA-MPs) or gelatin (Ge)-MPs (Ge-MPs). HA is a ubiquitous non-sulfated glycosaminoglycan found throughout the human body, often used for oral supplementation of HA and for enhancing vitamin stability. Examination of the HA-MPs and Ge-MPs by SEM revealed the presence of spherical particles with smooth surfaces. The average size of the HA-MPs and the Ge-MPs were determined to be approximately 5 μm in diameter. For example, the average size of the HA-MPs was estimated as 4±2 μm. In the second step, an oil-in-water (O/W) emulsion was used to encapsulate HA-MPs or Gel-MPs into an EPO matrix to synthesize the final HA-in-EPO MPs (HA-EPO-MPs) or Ge-in-EPO MPs (Ge-EPO-MPs). Cross-sectional SEMs and fluorescent labeling of HA revealed that HA-EPO-MPs exhibited a hierarchical particle-in-particle structure.

For encapsulation of fat-soluble MNs, a single-step emulsion process (FIG. 1B) was utilized to directly encapsulate MNs into the EPO matrix (EPO-MPs). In this case, cross-sectional SEMs revealed that the hierarchical structure of the HA-EPO-MPs was not present in EPO-MPs without HA-MPs.

HA-EPO-MPs, Ge-EPO-MPs, and EPO-MPs exhibited a spherical shape with a smooth surface and a size of approximately 200 μm in diameter. For example, the size of the EPO-MPs and HA-EPO-MPs was calculated as 214±16 μm.

Notably, the single-step emulsion process illustrated in FIG. 1B can be also used to encapsulate water soluble MNs. EPO-MPs encapsulating individual water soluble MNs, including vitamin C, vitamin B2, zinc, and iodine were produced (Table 2).

Individual Encapsulation and Release of Fat- and Water-Soluble Micronutrients

Representative fat soluble MNs including vitamin A and D and representative water soluble MNs including vitamin B2, B3 (niacin), B7 (biotin), B9 (folic acid), and B12, zinc, iodine, and iron were used as model MNs to establish the encapsulation approaches for fat- and water-soluble MNs. Formulations of the MPs encapsulating these representative MNs are summarized in Table 2. Vitamin A, B2, C, and D, zinc, and iodine were individually encapsulated via the one-step emulsion process, whereas vitamin B3 (niacin), B7 (biotin), B9 (folic acid), and B12, and iron were individually encapsulated via the two-step emulsion process.

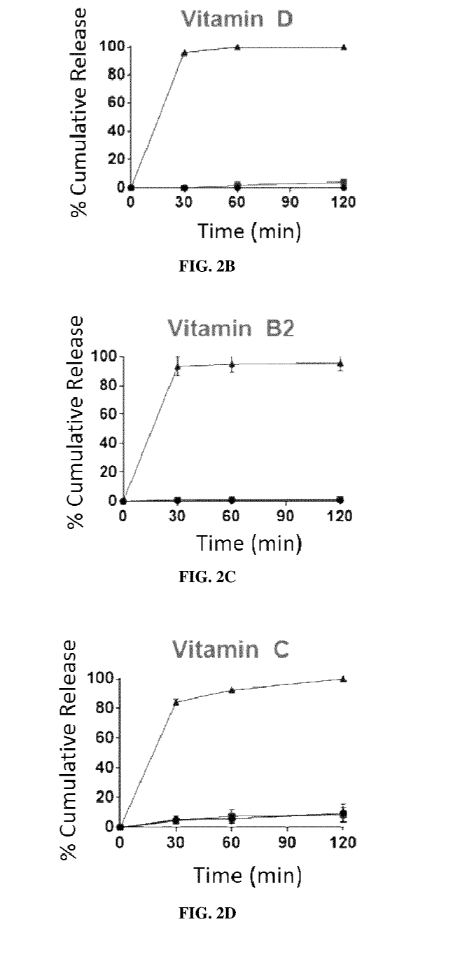

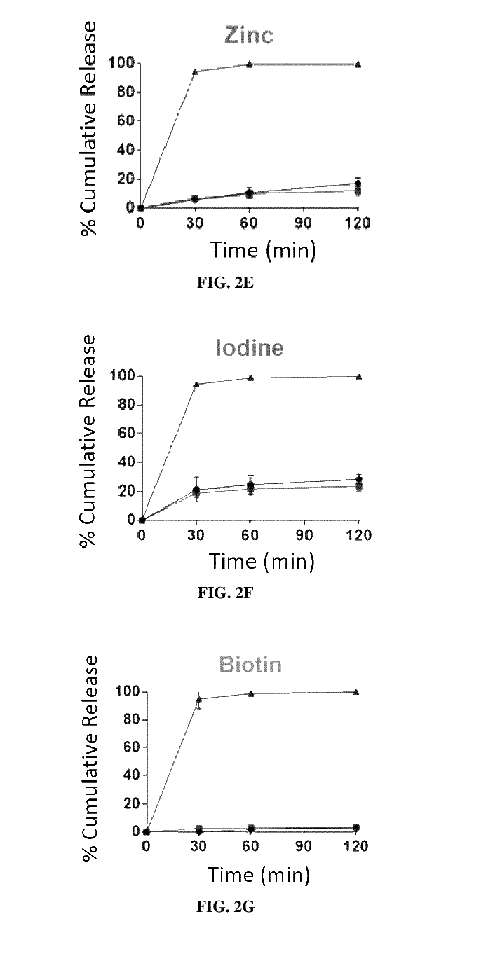

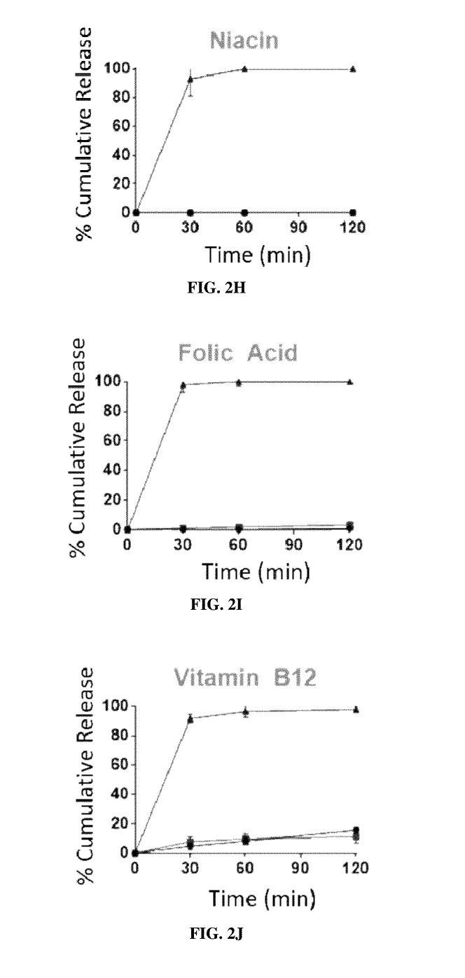

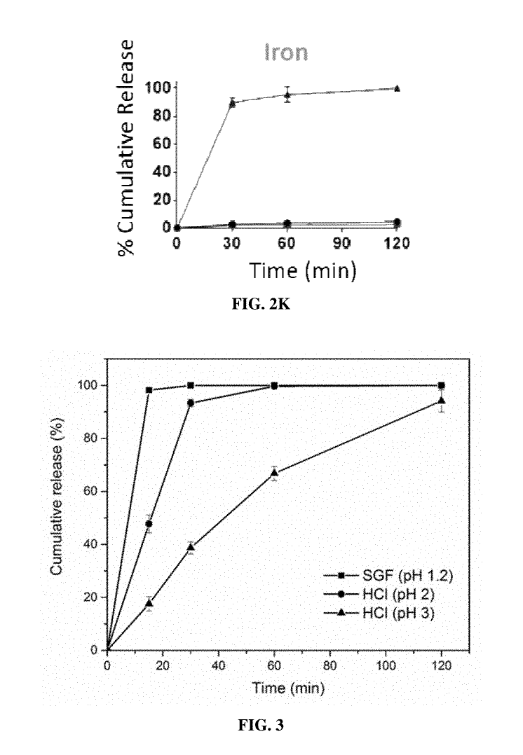

In vitro release studies confirmed the retention of micronutrients in the MPs following exposure to both room temperature (RT) water and boiling (100° C.) water (FIGS. 2A-2K). pH-responsive burst release was exhibited when particles were exposed to 37° C. simulated gastric fluid (SGF) at pH 1.5. Micronutrient retention during 2 h in boiling water was used as a baseline index of MP stability under simulated cooking conditions, since micronutrients such as vitamin A undergo chemical degradation when exposed to high temperature or humidity. The one-step process was confirmed to achieve retention (>80% at 120 min) in 100° C. or RT water and rapid release (>80% at 30 min) in 37° C. SGF for most individually encapsulated micronutrients (FIGS. 2A-2F). The two-step process was developed to further stabilize highly-water soluble micronutrients within the EPO matrix (FIGS. 2G-2K). More specifically, when the two-step process that included HA as the stabilizing biopolymer was used to encapsulate FeSO₄, the payload was largely retained (>90% at 120 min) in 100° C. or RT water and rapidly released (>80% at 30 min) in 37° C. SGF (FIG. 2K), whereas FeSO₄ formulations synthesized via the one-step process exhibited payload release, even in RT water. Retinyl palmitate (vitamin A) was used as a model MN to establish the encapsulation approach for fat soluble MNs. Vitamin A was directly incorporated into the EPO-MPs via O/W emulsion. Vitamin A EPO-MPs exhibited rapid payload release in SGF at 37° C. (FIG. 2A), which mimics the acidic gastric conditions in the stomach. When vitamin A EPO-MPs were subjected to water for 2 hours, both at room temperature and 100° C. boiling conditions, release of vitamin A could not be detected (FIG. 2A). Vitamin A EPO-MPs exhibited a smooth surface similar to MN-free MPs, likely due to the fat-soluble properties of both EPO and vitamin A Time-lapse microscopy was used to visualize vitamin A release from EPO-MPs when subjected to SGF at room temperature. Rapid dissolution (<1 minute) of the EPO-MP facilitated the release of the vitamin A payload, which can be seen as a diffuse circle of water-insoluble vitamin A growing in size with time.

Iron-loaded MPs, synthesized via the two-step emulsion process (FIG. 1A), which first encapsulates iron in HA and then into an EPO matrix to form iron HA-EPO-MPs, exhibited similar release profiles as compared to vitamin A EPO-MPs. The majority of the iron payload was rapidly released within 30 minutes in SGF and less than 5% was released in boiling and room temperature water after 2 hours (FIG. 2K). In contrast to the smooth vitamin A EPO-MP surface, iron-loaded HA-EPO-MPs exhibited a rough surface. Visualizing the cross-section of the iron-loaded HA-EPO-MPs via SEM, the loaded-iron can clearly be seen in the interior of the HA-EPO-MP, similar to the internal hierarchical structure of the MN-free HA-EPO-MPs. Analogous to the vitamin A EPO-MPs, the iron-loaded HA-EPO-MPs rapidly dissolve and release the iron-HA-MP payload in under a minute when exposed to SGF at room temperature.

These results highlight how two distinct encapsulation approaches for either water- or fat-soluble MNs, based on EPO-MPs, facilitate rapid release in gastric stomach conditions while limiting premature release in water conditions.

The role of pH in modulating release kinetics was investigated using vitamin B12 as a representative micronutrient, where payload release was achieved more rapidly at lower pH values (FIG. 3).

Micronutrient Stability Under Heat, Water, Ultraviolet Light, and Oxidizing Agents

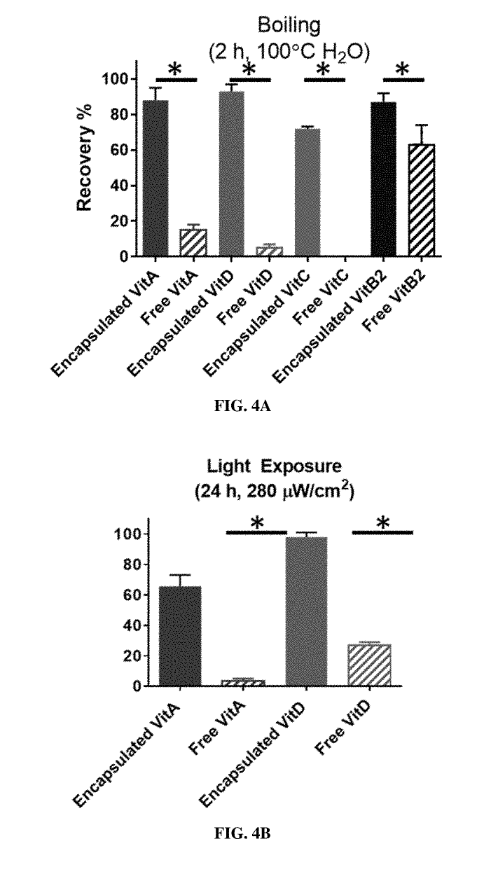

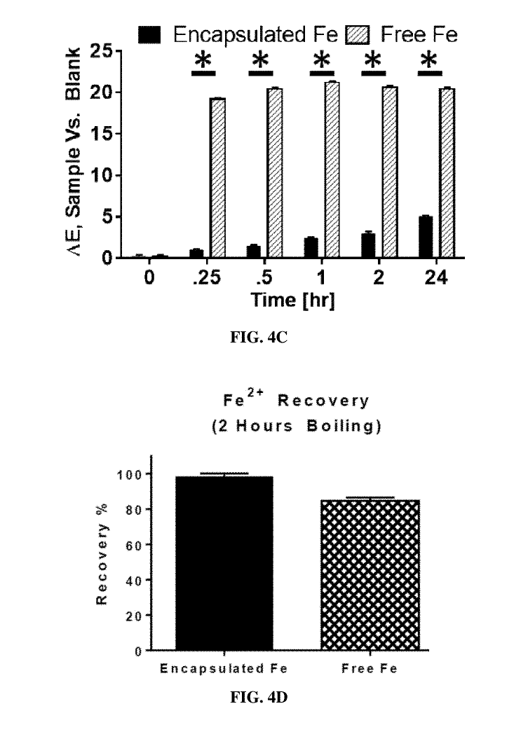

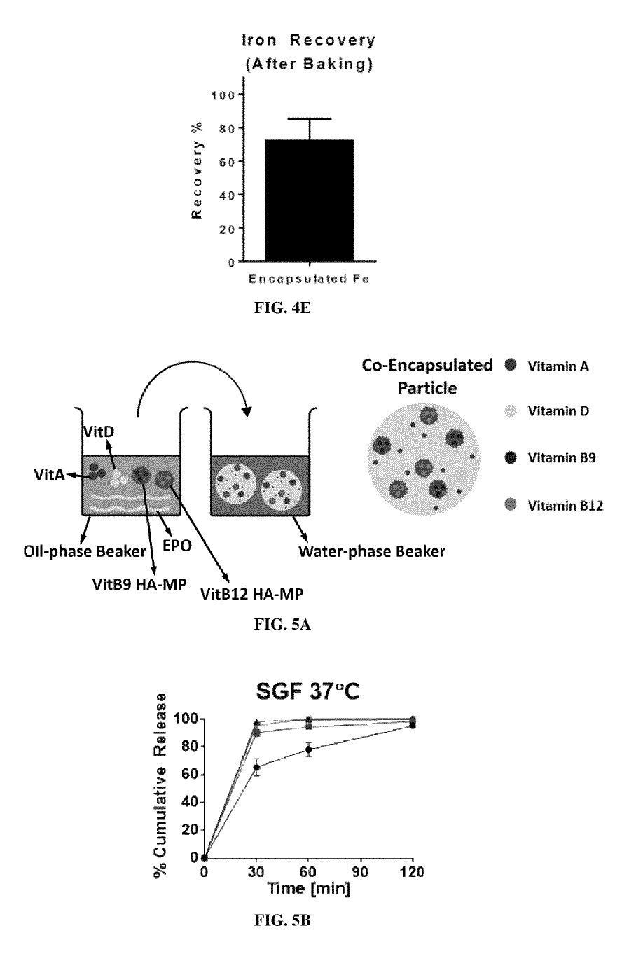

Many micronutrients, such as vitamin A and iron, are sensitive to high temperatures, moisture, ultraviolet light, or oxidizing chemicals, which can lead to degradation or changes in the oxidative states and thus limit absorption following ingestion. As such, the role that EPO encapsulation plays in improving micronutrient stability against these challenges was investigated for individually encapsulated formulations. The protection of the micronutrient payload was investigated after exposure to boiling water for 2 hours, which exposed the payload to high temperatures and moisture. For the encapsulated fat-soluble micronutrients vitamin A and D, over 5- and 18-fold enhanced recovery was observed, respectively, as compared to unencapsulated counterparts, following exposure to boiling water conditions for 2 hours (FIG. 4A). Similarly, encapsulation protected water-soluble vitamins C and B2 during boiling, as both water-soluble vitamins exhibited significantly enhanced recovery as compared to unencapsulated controls (FIG. 4A).

Protection of the micronutrient payload after 24 hours of light exposure (280 μW/cm²) was also investigated, since both vitamin A and vitamin D are rapidly degraded by ultraviolet light in their unencapsulated forms (FIG. 4B). Following encapsulation in EPO MPs, recovery after light exposure was significantly improved by over 15- and 3-fold for vitamin A and D as compared to unencapsulated controls, respectively (FIG. 4B).

Spontaneous oxidation-reduction reactions between micronutrients in fortified products and micronutrients naturally present in food sources can readily occur, and these reactions can negatively impact absorption and bioavailability. For example, polyphenols present in food catalyze iron oxidation, resulting in a dramatic color change, from a highly bioavailable ferrous (Fe²⁺) state to a ferric state (Fe³⁺) that exhibits poor bioavailability (Moore, et al., Journal of Clinical Investigation, 23, 755 (1944); Mellican, et al., Journal of Agricultural and Food Chemistry, 51, 2304-2316 (2003)). To examine whether EPO encapsulation prevents interactions between the encapsulated iron and oxidizing chemicals, EPO-encapsulated and unencapsulated iron was added to polyphenol-rich banana milk and the color change was quantified over time. Iron encapsulation in HA-EPO MPs exhibited significantly less color change, and therefore less oxidation, in banana milk as compared to unencapsulated iron (FIG. 4C). These results indicate that the EPO MP matrix can limit interactions between the encapsulated iron and the free polyphenols in food.

It was investigated how iron encapsulation in HA-EPO-MPs impacts oxidation during boiling in water in an open container, since both higher temperatures and atmospheric exposure will accelerate iron oxidation. For encapsulated iron, less than 2% oxidizes to ferric iron, and for non-encapsulated iron over 15% is oxidized to ferric iron (FIG. 4D). In this case, encapsulation of iron significantly improves resistance to oxidation to remain in the bioavailable ferrous state.

Recovery of iron from particles in baking conditions was also measured. After baking, >65% of the iron was recovered (FIG. 4E) and intact particles was retained, indicating that baking does not impact particle morphology.

To demonstrate a maintained capability for pH-controlled release of iron following exposure to high temperature, moisture, and oxygen, iron-loaded MPs that were first boiled for 2 hours and then immersed in SGF were visualized using real-time microscopy and it was confirmed that they maintain their ability to rapidly release their iron payload at low pH. After boiling, HA-EPO MPs retained similar morphology to pre-boiling.

Overall, these results indicate that encapsulation in EPO protects micronutrient payloads during exposure to high temperatures, moisture, ultraviolet light, and oxidizing chemicals.

Co-Capsulation of Fat and Water Soluble Micronutrients

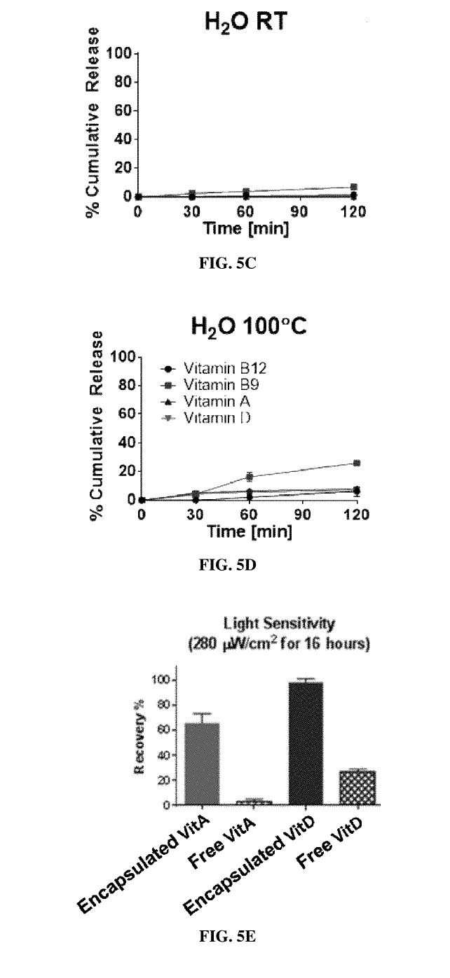

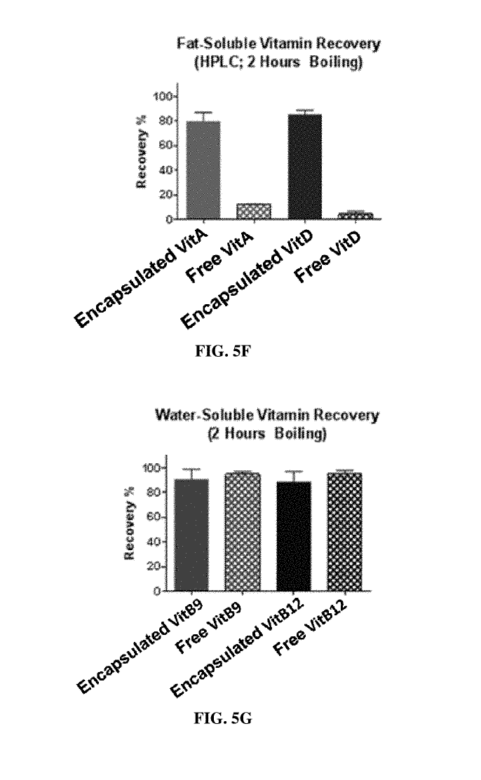

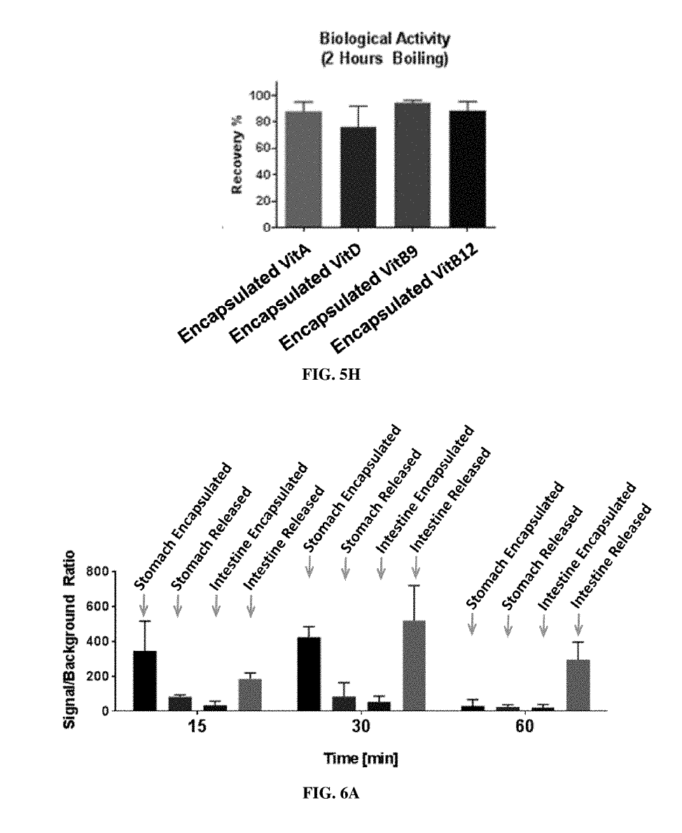

The two-step approach was additionally used to enable the co-encapsulation of four vitamins, water-soluble vitamins B12 and B9 (folic acid) introduced in step 1 to form HA-MPs encapsulating vitamin B12 and/or vitamin B9. These HA-MPs and fat-soluble vitamins A and D were added to an oil phase together with EPO, followed by an O/W emulsion (FIG. 5A). The co-encapsulated particles were tested for their release in SGF and stability in room temperature and boiling water. Heating during cooking is known to degrade MNs and thereby limit their absorption and metabolism. Similar to the vitamin A EPO-MPs and iron-loaded HA-EPO-MPs, the encapsulating EPO matrix facilitated rapid, and simultaneous, release of the co-encapsulated payloads in SGF at 37° C. (FIG. 5B). These payloads remained stable and did not release in water at room temperature for any of the MNs (FIG. 5C). Three of the co-encapsulated MNs (vitamins B12, A, and D) released <5% of their payload after 2 hours in water under boiling conditions (FIG. 5D). However, unlike the individually MN-loaded particles, <25% of vitamin B9 was released after 2 hours in water under boiling conditions (FIG. 5D) even though the stability of both released and encapsulated B9 is unaffected by these conditions. These results indicate that the EPO MP system be used to co-encapsulate micronutrients in a modular manner, provide retention during 2 hours in boiling water, and enable burst release in 37° C. SGF.

After 16 hours of light exposure (280 μW/cm²), both non-encapsulated vitamin A and D exhibited low recovery, 4±2% and 27±2%, respectively (FIG. 5E). However, following encapsulation in EPO-MPs, light sensitivity was significantly improved by over 15- and 3-fold for vitamin A and D (FIG. 5E), respectively.

After 2 hours of boiling in water, over 6- and 18-fold increase in vitamin recovery resulted from the EPO-MP encapsulated formulations for vitamins A and D, respectively (FIG. 5F). In the case of the water-soluble vitamins B9 and B12, HA-EPO-MP encapsulation provided no advantages in increasing vitamin stability during cooking conditions (FIG. 5G), likely due to vitamins B9 and B12 already being stable under cooking conditions without encapsulation.

Finally, the EPO-MP encapsulated MNs were tested for their ability to maintain biological activity following 2-hour boiling in water. In the case of the fat-soluble vitamins A and D, an ELISA assay was used to confirm bioactivity of the released MNs, whereas for the water-soluble vitamins B9 and B12, a microbiological assay was used.

In all cases, at least 75% of the encapsulated MNs maintained the ability to interact with biologically entities (FIG. 5H). Collectively, these results indicate that an EPO-MP system that co-encapsulates multiple fat- and water-soluble MNs enhances both the light and thermal stability of fat-soluble MNs and facilitates the preservation of all co-encapsulated vitamins' biological activity.

### Example 2

### In Vivo Studies on the Release of Payloads from EPO-MPs

Materials and Methods

Dissolution Study of DiR-Loaded EPO-MPs in Mice

Female SKH1-Elite mice (Cr1:SKH1-hr) were purchased from Charles River Laboratories at 8-12 weeks of age. Mice were fed an alfalfa-free balanced diet (Harlan Laboratories, AIN-76A) for 10 days prior to treatment to reduce food-related autofluorescence.

Approximately 200 mg of DiR-loaded EPO-MPs, prepared as described in Example 1, were administered in 100 μl of water via gavage (n=3). After 15, 30, or 60 minutes, mice were euthanized using carbon dioxide asphyxiation. The gastrointestinal tract was immediately explanted and imaged using In Vivo Imaging System (IVIS, PerkinElmer). The fluorescent signals from mice that had ingested DiR-loaded EPO-MPs were compared to mice that did not receive MPs. The spectral signatures associated with encapsulated and released DiR were then computationally separated from tissue autofluorescence (identified in the control samples) to determine the location and status of dye release. Quantified signal/background ratios were determined by normalizing the encapsulated or released dye signal, in either the stomach or intestines, to a background in control animals receiving no EPO MPs.

In Vivo Vitamin A Absorption in Rats

Tritium-labeled retinyl palmitate (American Radiolabeled Chemicals, Inc.) was used to detect the amount of absorbed vitamin A in blood. Radiolabeled VitA-EPO MPs were prepared by the O/W emulsion method described above. Female Wistar rats (˜250 g) were purchased from Charles River Laboratories. The rats were divided into two groups: (i) free vitamin A and (ii) VitA EPO-MPs. In the free group, vitamin A was delivered in a 4% v/v ethanol/water mixture to enable solubilization of vitamin A The VitA EPO-MPs were dispersed in water and vortexed to form a suspension. Each rat was oral gavaged 10 μCi of vitamin A in either its free form or encapsulated MPs in 350 μL of either ethanol/water mixture or water total. Residual vitamin A in the syringe and gavage needle were saved and quantified by scintillation counter to calculate the actual feeding amount of T-RP for each rat. At 0.5, 1, 2, 3, 4, 5, 6 hours, the rats were anesthetized via isoflurane and 200 μL of blood were collected from lateral tail vein. The radioactivity in the samples were quantified vita liquid scintillation counting with a Tri-Carb 2810 TR liquid scintillation counter. To calculate loading of vitamin A in the VitA EPO-MPs, the MPs were first dissolved in 1 mL dichloromethane, and then 5 μL of the solution was mixed with 10 mL Ultima Gold™ F liquid scintillation cocktail (PerkinElmer Inc.). Blood (200 μL) was dissolved in SOLVABLE™ (PerkinElmer Inc.) following recommended protocol, and then 1 mL of the dissolved blood was 10 mL Hionic-Fluor liquid scintillation cocktail as sample solution.

Results

Dissolution Study of DiR-Loaded EPO-MPs in Mice

To confirm EPO-MP dissolution in vivo, female SKH1-Elite mice were used to track payload release using EPO-MP encapsulated NIR fluorescent dye DiR (1,1′-dioctadecyl-3,3,3′,3′-tetramethylindotricarbocyanine iodide) as a model payload. DiR-loaded EPO-MPs were orally gavaged, and the complete gastrointestinal tract tissue was excised for ex vivo fluorescence imaging. Both the physical state of the dye, either encapsulated or released, and the physiological location of the dye in the gastrointestinal tract was visualized and quantified at 3 different time points, up to 1 hour.

It was confirmed that DiR could be differentiated in the encapsulated and released states by investigating the influence of environmental conditions on DiR's fluorescent properties using established imaging techniques (Ran and Moore, Molecular Imaging and Biology, 14, 293-300 (2012)). A 14 point spectral fingerprint of DiR-loaded EPO-MP was obtained when the DiR-loaded EPO-MP was suspended in water. In contrast, when DiR was released from the EPO-MP in SGF, DiR exhibited a blue shift. This shift exhibited a distinct spectral profile from encapsulated DiR, and as such the encapsulated and released DiR could be differentiated using their distinct fluorescent fingerprints. The two fingerprints of the dye in encapsulated form or released form were used to indirectly reflect the dissolution of the EPO-MPs in vivo.

At 15 minutes, the stomach contained a mixture of encapsulated and released DiR, suggesting that the EPO-MPs were partially dissolved and a portion of payload was released but had not yet entered the intestines.

At 30 minutes, the majority of DiR signal was detected as released dye in the intestines.

At 60 minutes, minimal signal of EPO-MP encapsulated DiR was detectable, highlighting how all particles released their payload at 1 hour. Furthermore, the released dye signal was exclusively in the intestines, implying that the released payload effectively leaves the stomach and enters the intestines for absorption.

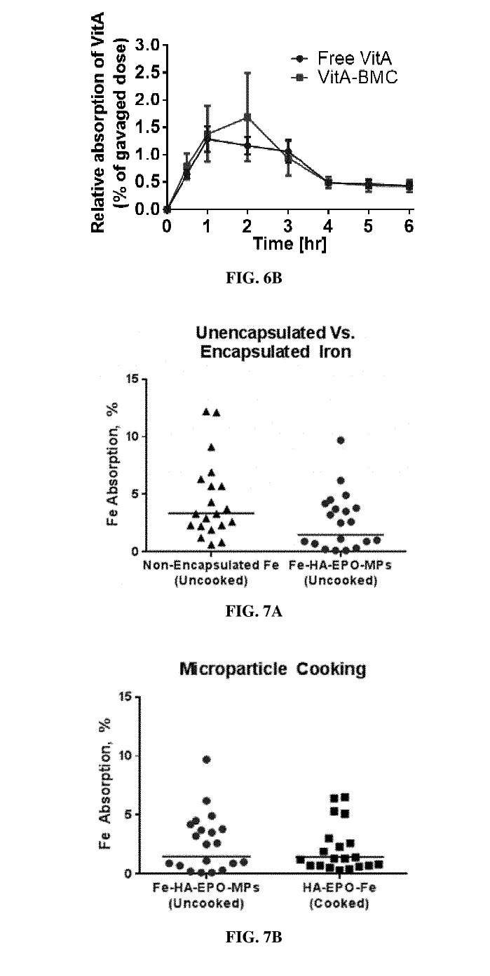

FIG. 6A shows the quantitative analysis of encapsulated-dye in the stomach, released-dye in the stomach, encapsulated-dye in the intestines, and released-dye in the intestines.

These findings confirm rapid release of a model payload from orally administered MP into the murine gastrointestinal tract.

In Vivo Vitamin A Absorption in Rats

To determine whether the rapid in vivo release of payload from EPO-MPs would facilitate absorption of encapsulated micronutrients, the absorption of vitamin A in female Wistar rats was investigated. Tritium-labeled vitamin A was orally administrated to rats by gavage in both the free form and EPO-encapsulated forms and blood samples were taken to evaluate vitamin A content over a period of 6 hours (FIG. 6B). Encapsulated vitamin A exhibited statistically indistinguishable absorption relative to free vitamin A (FIG. 6B), highlighting that encapsulation in EPO did not influence absorption.

### Example 3

### Clinical Study 1: Iron Bioavailability of Lab-Scale Fe-HA-EPO MPs

Materials and Methods

Participants

The human studies had a randomized single-blind, cross-over design. In study 1 and study 2 participants were recruited among female students at the Swiss Federal Institute of Technology in Zurich (ETH), and University of Zurich (UZH). Inclusion criteria were: female, apparently healthy, 18 to 40 years old, low iron stores (plasma ferritin<25 μg/L), body weight<65 kg, body mass index 18.5-25 kg/m2, non-pregnant (assessed by a pregnancy test) non-lactating, hemoglobin>90 g/L, normal C-reactive protein (<5.0 mg/L), no chronic disease or medications (except for oral contraceptives), no consumption of mineral and vitamin supplements within the 2 weeks before 1st test meal administration, no blood transfusion, blood donation or significant blood loss (accident, surgery) during the past 4 months, signature of informed consent.

Ethical approval for both studies were provided by the ethical review committee of Cantonal Ethics Commission of Zurich (Human study 1: KEK-ZH-Nr. 2015-0094; Human study 2: KEK-ZH-Nr. 2017-01624) and the Committee on the Use of Humans as Experimental Subjects at MIT (Human study 1: COUHES #1502006932; Human study 2: COUHES #1801201448/1801201448A001); both trials were registered on ClinicalTrials.gov under Identifier NCT02353325 for human study 1 and NCT03332602 for human study 2.

Study Design

Two studies were performed using a single blind, randomized cross-over design. In study 1 three test meals consisting of a maize porridge were administered, and in study 2 participants consumed nine wheat bread test meals. All test meals were labelled with 4 mg Fe as FeSO₄ using stable iron isotopes (⁵⁴Fe, ⁵⁷Fe, or ⁵⁸Fe). Labeled FeSO₄ was prepared by Dr. Paul Lohmann GmbH (Germany) from isotopically ⁵⁴Fe- ⁵⁸Fe and ⁵⁷Fe-enriched elemental iron (Chemgas, Boulogne, France). Vitamin A (BASF), HA (Bloomage Freda Biopharm Co., Ltd.), and folic acid (Spectrum Chemical) were all food grade. Different participants were included in each study, after enrollment each participant was allocated to a predefined schedule of test meal combinations in a randomized balanced block design and each participant served as their own control. In study 1 the test meals were maize porridge to which fortified salt was added either before or after cooking. The study was powered to detect a 35% within group difference in iron absorption, based on a standard deviation of 0.23 from log transformed iron absorption, a type I error rate of 5% and 80% power. This calculation yielded a sample size of 20 subjects. Subjects consumed 3 iron stable isotope-labeled test meals in a random order (randomized balanced block design). Two meals contained 4 mg Fe as labeled FeSO₄ (either ⁵⁴Fe or ⁵⁸Fe) in iron-loaded EPO-HA-MPs and one meal contained labeled iron (⁵⁷Fe). The test meals were maize porridge to which fortified salt was added either before or after cooking. The amount of iron added to the porridge through fortified salt would roughly correspond to a level of 60 ppm iron in directly fortified maize flour. The fortified salt contained either: a) FeSO₄ (reference); b) iron-loaded EPO-HA-MPs added before cooking; or c) iron-loaded EPO-HA-MPs added after cooking. The test meals were administered within one week on 3 consecutive days. The study duration from screening to the final venipuncture was 24 days.

In study 2 the test meals were a wheat bread which was fortified before baking. The amount of iron added to the bread was 67 ppm iron in wheat flour. The test meals contained either (a) iron-loaded EPO-HA-Fe (3.19%); (b) iron-loaded EPO-HA-Fe (18.29%); (c) iron-loaded HA-Fe (8.75%); (d) iron-loaded EPO-HA-Fe (3.19%) with VitA-EPO (3.4%; 37.65 mg vitA); (e) iron-loaded EPO-HA-Fe (3.19%) with VitA-EPO (3.4%; 37.65 mg vitA) with free folic acid (0.34 mg); (f) FeSO₄; (g) FeSO₄ with HA (25.68 mg to match HA in group (a)); (h) FeSO₄ with EPO (85.19 mg to match EPO in group (a)); or (i) FeSO₄ with EPO (85.19 mg to match EPO in group (a)) with HA (25.68 mg to match HA in group (a)).

Study Procedure

Study 1 was conducted in March-April in 2016 at the Laboratory for Human Nutrition (HNL) in Zürich. 118 participants attended the screening 1-2 weeks before test meal administration, weight and height were measured, a blood sample for Hb, PF and CRP measurement was collected, and 20 participants meeting the inclusion and exclusion criteria were invited to participate. Two-thirds of the subjects were iron deficient; none were anemic. All meals contained 4 mg iron as labeled FeSO₄. Meals with EPO-HA-Fe microspheres contained 800 mg EPO and 40 mg HA. Prior to administration, the iron-loaded EPO-HA-MPs were tested and declared negative for solvent residuals, endotoxins, and microbial bioburden according to US pharmacopeia.

The standardized test meals were prepared fresh each study day. They consisted of porridge made from 50 g whole maize flour, served with 30 g vegetable sauce (44% cabbage, 21% carrots, 21% zucchini, 12% onions, 2% oil) and 2.5 g salt. Depending on the test meal, the 2.5 g salt was fortified with either FeSO₄ or the iron-loaded EPO-HA-MPs added to the test meal before or after cooking (1 hour baking at 100° C.). The maize flour contained 1.52 mg Fe/100 g and 736.8 mg phytic acid /100 g. Each test meal contained 50 g of maize flour and an additional 4 mg of fortification iron; thus, total iron and phytic acid content in the test meals was 4.8 mg Fe and 368 mg phytic acid, resulting in an iron to phytic acid ratio of 1:6.5. Ascorbic acid content of the test meals was negligible, 0.4 mg/meal. Thus, the test meal matrix was an inhibitory matrix in terms of iron absorption. The vegetable sauce was prepared in bulk and stored frozen in portions until administration. Maize flour was precooked as follows: on the night before test meal administration, each individual maize portion was mixed with warm 18 MΩ/cm water, preheated in the microwave (1 min, 600 W), and then baked in an oven at 100° C. for 60 min.

After overnight refrigeration, on the administration day, maize porridge was preheated in the microwave for 1 minute at 600 W, and then cooked for further 30 min in the oven (100° C.). The test meals with the cooked iron-loaded EPO-HA MPs were fortified before the microwaving step. The test meals with the non-cooked iron-loaded EPO-HA MPs were cooled down for 10 minutes to just under 50° C. before the microspheres were added. The defrosted and preheated vegetable sauce was added just before serving. Nanopure water (300 ml) was served as a drink with the test meals.

Test meals A, B and C were administered on 3 consecutive days (study days D1, 2 and 3). The subjects were instructed to consume no solid food after 21.00 and no fluids after 24.00 on the evening before test meal administrations. They consumed the test meals between 07.00-09.00 each morning under direct supervision. Subjects consumed the entire meal, the bowl was rinsed twice with 10 ml water and participants drank the rinsing liquid and remained fasting (no food nor drink) for 3 hours after test meal administration. On D 17, a venous blood sample was taken for determination of Hb, PF, CRP, and determination of stable iron isotope ratio into the erythrocytes.

Study 2 was conducted between April-July 2018 at the HNL. Prior the test meals, 77 participants attended screening, weight and height were measured, a blood sample for Hb, PF and CRP measurement was collected, 24 eligible participants were invited to participate. The participants were instructed with the same fasting conditions as in study 1. After consuming the entire bread test meal, the participants were instructed to consume all bread crumbs that had fallen into the plate. As in study 1 the participants remained fasting for 3 hours after test meal administration. The 9 test meals were administered in 3 blocks, within the first week, 3 test meals were administered on 3 consecutive days (D1, 2, and 3). On D22 a blood sample was drawn for determination of Hb, PF, CRP, and determination of stable iron isotope ratio into the erythrocytes. The next block of test meals was administered on D22, 23 and 24, and again on D43 a blood sample was drawn, within that week the last block of test meals was administered on D43, 44 and 45. The last blood sample was taken on D64. All bread roll test meals were prepared the afternoon before test meal administration, two doughs were prepared made of 1 kg refined wheat flour each, 5.5 g salt, 14 g dry yeast and 650 g of nanopure water, the dough was kneaded for 10 min using a kitchen machine. And then weighed into portions of 100 g. ⅓rd of the portion was fortified with the microspheres, and ⅔rd of the portion was used to cover the fortified core. After forming, the bread rolls were fermented for 45 minutes at 30° C. and 80% relative humidity, and then baked for 20 minutes at 190° C. They cooled down on a cooling rack and wrapped in paper and stored at RT until consumption the next morning. The bread rolls consisted of 59.9 g wheat flour, 0.3 g of salt and 0.8 g of dry yeast. 300 ml of nanopure water was served as a drink.

Test Meal Analysis and Blood Analysis

Labeled iron compounds were analyzed before the start of the study for iron isotopic composition and tracer iron concentration by reversed isotope dilution mass spectrometry by using the experimental techniques outlined below. Hb was measured by using a Coulter Counter (Study 1: Beckman Coulter, CA, USA; Study 2: Sysmex XN-350). Plasma ferritin (PF) and C-reactive protein (CRP) were measured by immunoassays (Study 1: Siemens Healthcare IMMULITE 2000; study 2: IMMULITE1000). Anemia was defined as Hb<12 g/dL, Iron deficiency (ID) as PF<15 mg/L and ID anemia as Hb<12 g/dL and PF<15 mg/L.

Sample analyses of the test meals were done in triplicate. Iron concentrations of the maize flour and bread rolls were measured by graphite-furnace atomic absorption spectrophotometry (AA240Z; Varian) after mineralization by microwave digestion (MLS ETHOSplus, MLS). The phytate concentration of the maize flour and the bread roll was measured by spectrophotometry using the Makower method, in which iron was replaced by cerium in the precipitation step (Makower, Cereal Chem, 47, 288-& (1970)). Ascorbic acid concentration in the test meals was by HPLC (Acquity H-Class UPLC System; Waters AG) after stabilization in 10% metaphosphoric acid.

Whole blood samples collected on D17 (study 1) and in study 2 on D22, 43, and 64 were mineralized using an HNO₃/H₂O₂ mixture and microwave digestion followed by separation of the iron from the blood matrix by anion-exchange chromatography and a precipitation step with ammonium hydroxide. All isotopic analyses were performed by using MC-ICP-MS (Neptune; Thermo Finnigan). The amounts of ⁵⁷Fe, ⁵⁴Fe and ⁵⁸Fe isotopic labels in blood 14 d after administration of the test meals were calculated on the basis of the shift in iron isotope ratios and on the estimated amount of iron circulating in the body. Circulating iron in the body was calculated based on the hemoglobin and blood volume, derived from the participant's height and weight. Fractional absorption (FIA) was calculated based on the assumption of an 80% incorporation of absorbed iron into the red blood cells. In study 2, the isotopic ratio value of D22 and 43 served as a new baseline value for the following test meal administrations. Relative bioavailability (RBV) of iron was calculated as follows: 100/FIA_{reference meal}*FIA_{test meal}.

Statistical Analysis

Statistical significance was evaluated using a two-tailed Student's t-test. A P value of <0.05 was considered to be statistically different. Both human studies were powered to detect a nutritionally relevant, 30% within group difference in iron absorption, based on a standard deviation of 0.35 from log transformed iron absorption, a type I error rate of 5% (two tailed) and 80% power; this calculation yielded a sample size of 18 subjects. In study 1 a drop-out rate of 10% was anticipated, and therefore 20 participants were recruited, in study 2 a drop-out rate of 30% was anticipated due to the longer duration of the study, and therefore 24 subjects were recruited.

Statistical analysis was done using SPSS Version 22 (human study 1) and Version 24 (human study 2) (IBM SPSS Statistics). All data were checked for normal distribution before analysis, Age, weight, height, Hb, CRP were normal and the data are presented as means and standard deviations. PF, and fractional Fe absorption are non-normal and presented as geometric means and 95% CI. Comparisons between meals were done using the square root transformed data fitted in a linear mixed model. Meals were entered as a repeated fixed factor (covariance type of scaled identity) and subjects as random factors (intercept). If a significant overall effect of meals was found, post-hoc tests within different meals were performed using the Bonferroni correction for multiple comparisons. The level of significance was set at p value <0.05.

In study 1, general linear mixed models were fitted to the data using SPSS (Version 22, IBM Corporation) on log-transformed data. Meals were entered as fixed factors [Maize FeSO₄; Maize iron-loaded EPO-HA-MPs (pre-cooking), Maize iron-loaded EPO-HA-MPs (post-cooking)] and subjects as random factors (intercept). If a significant overall effect of meals was found, post-hoc tests within different meals were performed using the Bonferroni correction for multiple comparisons.

Results

Iron-deficiency anemia is one of the most prevalent MN deficiencies in the developing world and is also a concern is the developed world, as many new technologies are being developed to deliver iron to patients suffering from chronic kidney disease. As such, iron-loaded HA-EPO-MPs were further evaluated to investigate their efficacy in facilitating iron absorption in humans. The EPO-MP matrix protects fat-soluble MNs from thermal degradation. However, protection of water-soluble MNs such as B9 and B12 was not established since both B9 and B12 are inherently heat-stable. Unlike B9 and B12, iron can oxidize from a highly bioavailable ferrous (Fe²⁺) state to a ferric state (Fe³⁺) that exhibits poor bioavailability. Therefore preventing iron oxidation in oral iron supplementation is essential.

Lab-scale Fe-HA-EPO MPs were investigated for their ability to deliver bioavailable iron in humans Iron absorption in humans was investigated through the consumption of 3 iron stable isotope-labeled test meals administered in a randomized single-blind, cross-over design to fasting young women (n=20, hemoglobin (Hb)=13.4±0.85 g/L, and geometric mean (95% CI), plasma ferritin (PF) 11.6 (9.4, 14.5) μg/L) (Table 3). Two meals contained 4 mg iron as labeled FeSO₄ (either ⁵⁴Fe or ⁵⁸Fe) in HA-EPO-MPs and one meal contained labeled iron (⁵⁷Fe). The test meals were maize porridge where iron-fortified salt was added either before or after cooking. Uncooked encapsulated iron was directly compared with uncooked non-encapsulated iron. Iron-loaded HA-EPO-MPs exhibited ˜45% of the relative iron absorption as compared to free non-encapsulated iron (P<0.01) (FIG. 7A). While the spread of the data was quite broad, the geometric mean for free uncooked iron was 3.36, whereas the geometric mean for uncooked microencapsulated (EPO-HA-Fe) iron was 1.46 (Table 4).

TABLE 3
Subject characteristics of human study 1 and 2. All female, no
significant difference in baseline characteristics between the study
populations.
Baseline subject characteristics of
study participants for human study 1 and 2

| Characteristics | Study 1 | Study 2 |
|---|---|---|
| n (number of subjects) | 20 | 24 |
| Age^{b} [year] | 22.8 ± 3.5 | 22.4 ± 1.9 |
| Height [meter] | 1.66 ± 0.06 | 1.64 ± 0.06 |
| Weight [kg] | 57.3 ± 4.1 | 57.8 ± 6.2 |
| Body Mass Index [kg/m²] | 20.8 ± 1.5 | 21.3 ± 1.4 |
| C-Reactive Protein^{c} [mg/L] | 0.62 (0.36, 1.07) | 1.07 (0.72, 1.59) |
| Plasma Ferritin [μg/L] | 11.6 (9.4, 14.5) | 13.2 (10.5, 16.5) |
| % Iron Deficient^{d} (PF < 15 μg/L) | 65 | 58 |
| Hemoglobin [g/L] | 13.4 ± 0.85 | 13.2 ± 0.95 |
| % Anemic^{c} (Hemoglobin < 120 | 5 | 8 |
| g/L) | | |
| % IDA^{f} | 5 | 4 |

^{a} independent t-test, p < 0.05
^{b}all such values are mean ± SD
^{c}all such values are geometric mean (95% CI)
^{d}ID, Iron deficiency, defined as PF < 15 μg/L
^{e}Anemia, defined as Hb < 120 g/L
^{f}IDA, iron deficiency anemia, defined as PF < 15 μg/L and Hb < 120 g/L

TABLE 4
Tabulated clinical results for fractional iron absorption in human
study 1.

| | Fractional Fe Absorption^{1, 2} [%] |
|---|---|
| Non-Encapsulated Fe | 3.36 (1.48, 7.64)^{a} |
| (Uncooked) | |
| Fe-HA-EPO-MPs | 1.46 (0.37, 5.83)^{b} |
| (Uncooked) | |
| Fe-HA-EPO-MPs | 1.41 (0.55, 3.63)^{b} |
| (Cooked) | |

¹As geometrc mean (±SD), all such values.
²Significant effect of meal on iron absorption by linear mixed effect models. Different subscripts differ significantly by Bonferroni corrected post-hoc paired comparisons (t-test, P < 0.01).

Iron-loaded HA-EPO-MP was next compared in cooked and uncooked conditions. In this case, the iron absorption geometric mean for uncooked iron-loaded HA-EPO-MPs was 1.46, whereas the Fe absorption geometric mean for cooked iron-loaded HA-EPO-MPs was 1.41 (Table 4). These results highlight how cooking HA-EPO-MP-encapsulated iron does not impair its absorption, as there was no significant difference in iron absorption for microencapsulated iron that was cooked or uncooked (FIG. 7B). While the clinical study clearly showed that iron-encapsulation in HA-EPO-MPs inhibits iron absorption as compared to non-encapsulated when not subjected to cooking, the lab-scale and lab-developed formulation demonstrated efficacy in delivering bioavailable iron to humans, independent of cooking conditions.

### Example 4

### Scaling Up Production

All MPs described to this point were conceived and synthesized as small-scale research lab formulations. While emulsion-based microencapsulation methods are a staple in a large percentage of biomaterial and formulation labs at the academic level, they limit the clinical and commercial translation of many exciting technologies. As such, this lab-scale technology was scaled-up for synthesis of large-scale iron-loaded HA-EPO-MPs and vitamin A-loaded EPO MPs for industrial transition.

Materials and Methods

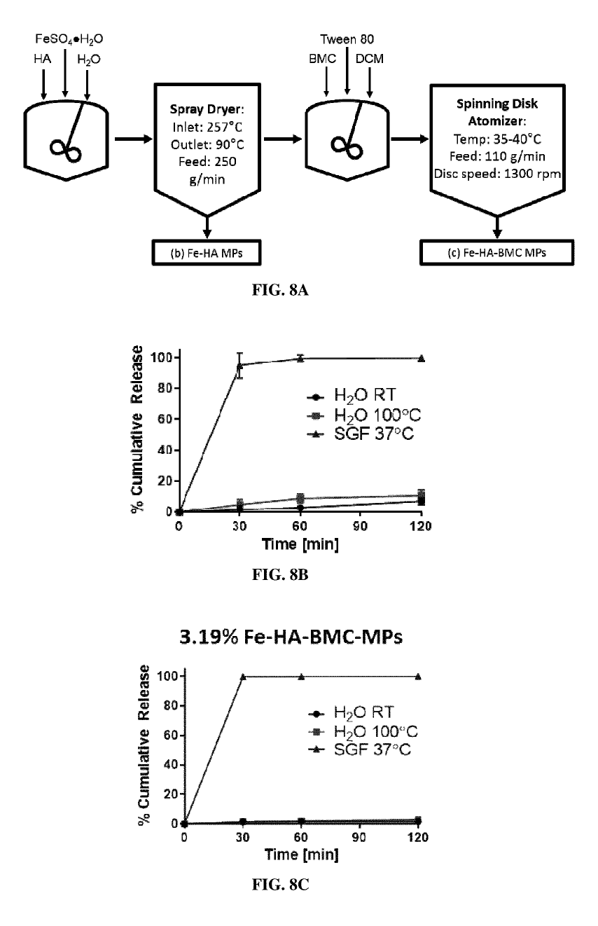

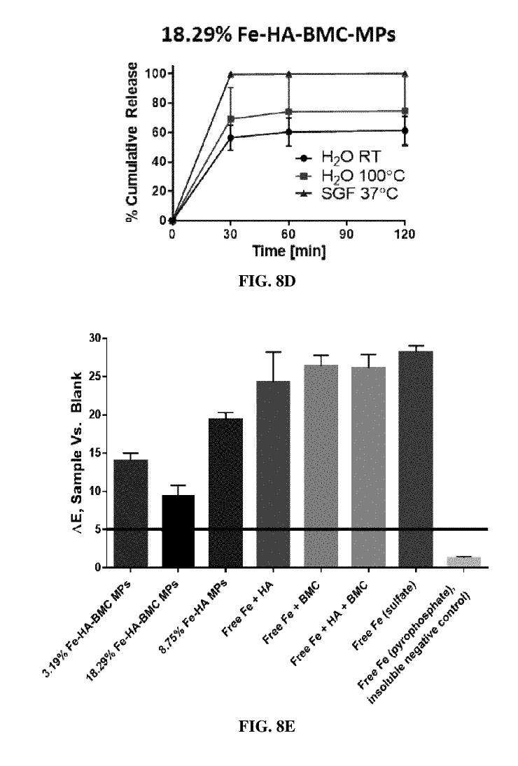

Scale-up production of Fe-HA-EPO MPs The process used to manufacture 1 kg or more of Fe-HA-EPO MPs is shown in FIG. 8A. Commercially-available spray dryers were used to formulate iron HA-MPs in place of the initial W/O emulsion. The second emulsion step used for the lab-scale formulations was replaced with a commercially available spinning-disk atomizer

A Niro Production Minor pilot scale spray dryer was used to first prepare Fe-HA MPs. The feed solution contained 525.5 g sodium hyaluronate, 1309.5 g iron sulfate monohydrate, and 77 L of deionized water. This solution was fed into the dryer at 250 g/min and atomized with a 2 mm two-fluid nozzle. The dryer inlet temperature was set to 257° C., resulting in an outlet temperature of 90° C. 1215 g of MPs was recovered.

Fe-HA MPs were encapsulated with EPO using a custom spinning disc atomization system. The feed solution was prepared with 1152 g of EPO and 1.87 g of polysorbate 80 dissolved in 12000 g of dichloromethane (DCM). 48 g of Fe-HA MPs was added to the DCM solution and placed in a sonication bath for 10 minutes to form a stable suspension. The suspension was fed at 110 g/min onto a 4 in. diameter stainless steel custom disc spinning at 1300 rpm. The disc was mounted 30 ft. high in a 20 ft.×20 ft. tower. The room was heated to 35-40° C. Particles were collected on antistatic plastic located at the bottom of the tower. 1059 g of MPs were recovered.

These processes were modified for batches used in human study 2 by using a Pro-CepT 4M8 laboratory spray dryer for the Fe-HA MPs.

All new tubing and filters were used with the spray dryer, in addition to cleaning all wetted parts with soapy water and a 70% aqueous IPA solution. The inlet temperature for the spray dryer was set to 160° C., resulting in an outlet temperature of approximately 53° C. Solution was dried at 8 mL/min through a 0.4 mm air atomized nozzle.

The same spinning disc setup was used for encapsulating the Fe-HA MPs within EPO. The tower was mopped and cleaned, followed by treatment with Vesphene Ilse.

Scale-Up Production of Vitamin A-Loaded EPO MPs

Encapsulated vitamin A for feed studies was also prepared using the same spinning disc system. Vitamin A in the form of retinyl palmitate was dissolved in an organic solvent together with EPO, followed by spinning disc atomization into starch powder. A disc speed of 1675 rpm was used as the feed solution was fed to a 4 inch spinning disc at approximately 115 or 85 g/min. The material was collected in a powdered DryFlo® starch. The excess starch was then sieved from the sample to recover the vitamin A MPs. All samples were placed under vacuum with a slow N₂ purge for 1 week to remove residual DCM.

In some forms, the formulation contains 2 g retinyl palmitate, 18 g EPO (from Evonik), and 270 g methylene chloride.

Direct replacement of methylene chloride with acetone was performed to test the effect of solvent on atomization. The resulting EPO MPs were produced using the same method as described above.

Direct replacement Evonik EPO by an alternative, Vikram EPO (Vik-EPO) was also performed. The resulting EPO MPs were produced using the same method as described above.

Extrusion of vitamin A into EPO was performed to produce particles or powders containing vitamin A Extrusion is a solvent-free/non-aqueous process. Compared to spray drying, this method can achieve high-throughput and have better availability.

Results

Scale-Up Production of Fe-HA-EPO MPs

The MPs described to this point were conceived and synthesized as lab-scale research formulations. While emulsion-based microencapsulation methods are a staple in many biomaterial and formulation labs at the academic level, significant challenges in increasing the iron loading when encapsulated in EPO was encountered. To address this, and in order to overcome the absorption issues that were encountered in the first human study, new processes to increase the loading of iron in the micronutrient formulations were developed (FIG. 8A). A commercially-available spray dryer and a customized spinning-disc atomizer were used to formulate Fe-HA MPs and Fe-HA-EPO MPs, respectively, at the kilogram scale. The initial scaled formulation was designed to recreate the 0.6% iron loading used in the first human study. Batches of Fe-HA-EPO MPs produced at the pilot scale (>1 kg) and at the same compositions of those used in the first human study met the same loading, stability, and pH controlled release criteria as the lab-scale formulation tested in humans (FIG. 8B).

In shifting toward the large-scale batch, the iron-loaded HA-EPO-MPs exhibited: (i) similar size to the lab-scale formulation, (ii) structural changes as the particle morphology is now slightly deflated/dented spheres, (iii) near-identical release profiles in SGF at 37° C., water at room temperature and at 100° C. (FIG. 8B), and (iv) similar protection of iron against oxidation during open-container boiling.

A second water-soluble MN, zinc oxide, was added to both act as a color masking agent and as an initial example to highlight the scaled-up co-encapsulation of 2 distinct MNs in a single particle. A wide percentage range of zinc oxide, from 0% to 95% of the total micronutrient, was tested. MPs with a low percentage of zinc oxide exhibited a brownish color due to a high concentration of iron in the MPs, whereas MPs with a high percentage of zinc oxide exhibited a pale white color due to a low concentration of iron.

Processes to increase the loading of iron in EPO particles to 3.19% (FIG. 8C) and 18.29% (FIG. 8D), which additionally decreased EPO amounts (Table 5). These scaled MPs were also examined for their ability to prevent interactions between the encapsulated iron and oxidizing chemicals present in food as described above with polyphenol-rich banana milk. It was demonstrated that the scaled Fe-HA-EPO MPs induced less color change as compared to all free forms of iron, both with and without the other MP constituents (i.e. HA, EPO, and HA with EPO) (FIG. 8E).

Scale-Up Production of Vitamin A-Loaded EPO MPs

Scale-up production using spinning disc atomization into starch powder produced vitamin A-loaded EPO MPs that are different from those produced by the lab-scale method.

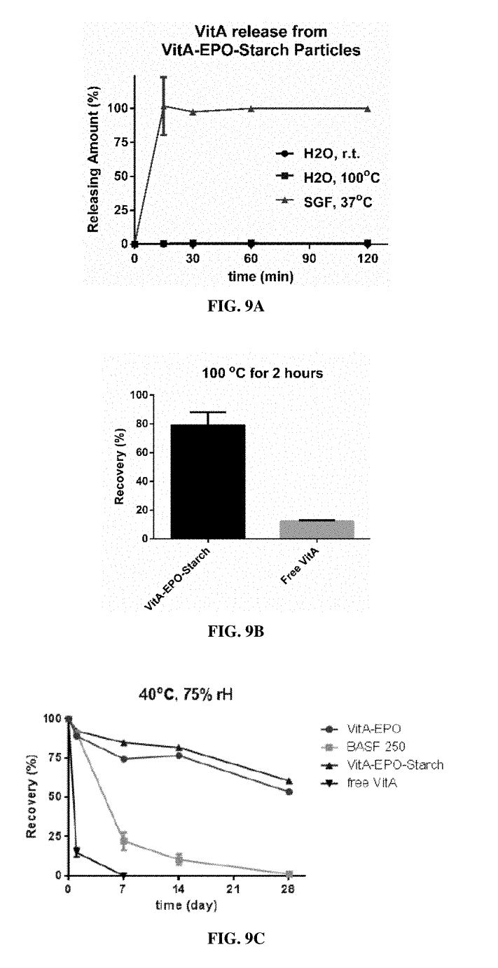

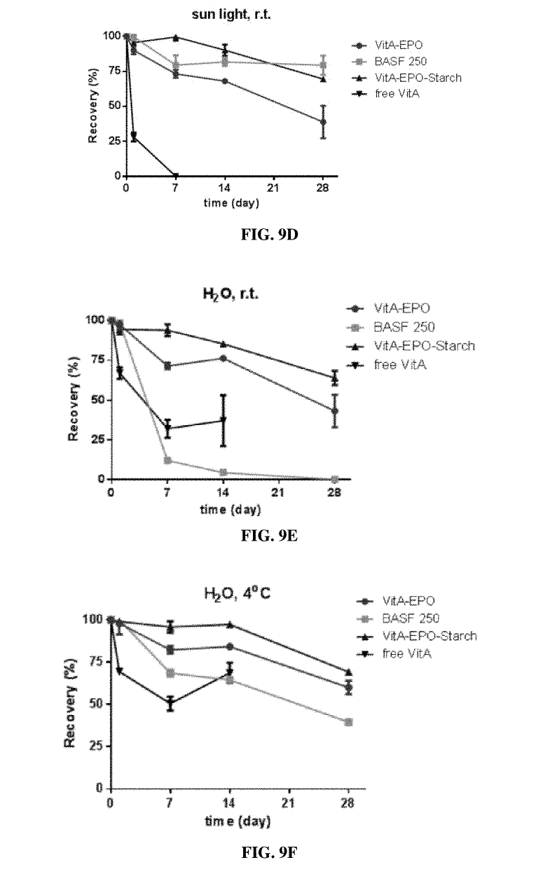

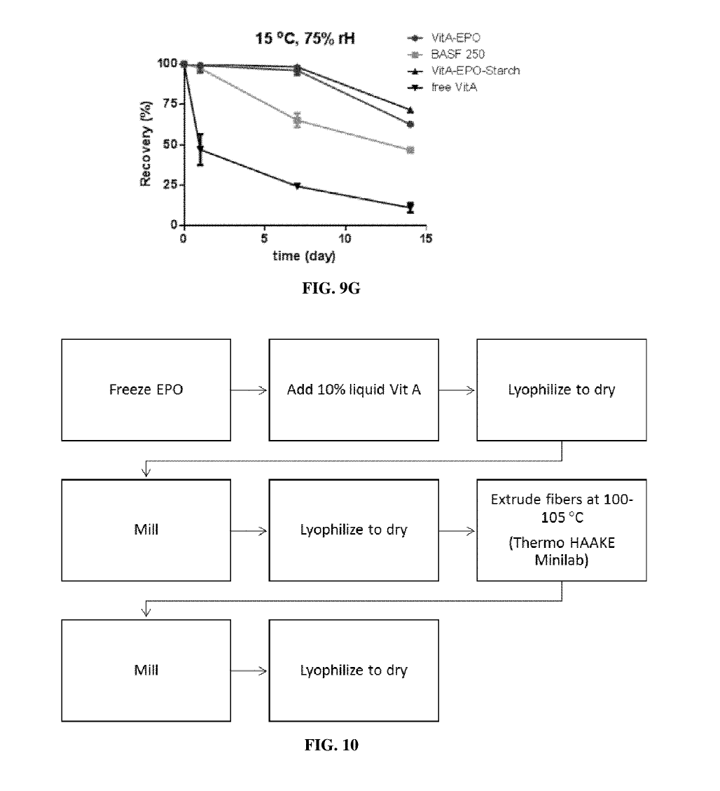

In shifting toward the large-scale batch, the vitamin A-loaded EPO MPs exhibited (i) structural changes as the particles are coated with starch, (ii) similar release profiles in SGF at 37° C., water at room temperature, and water at 100° C. (FIG. 9A), and (iii) similar recovery rate after boiling in water for 2 hours (FIG. 9B).

The stability of the lab-scale vitamin A-loaded EPO MPs, a commercially available BASF vitamin A formulation, and the scale-up vitamin A-loaded EPO MPs was compared under a variety of conditions, including (1) 40° C., 75 humidity (FIG. 9C), (2) exposure to sunlight at room temperature (FIG. 9D), (3) suspended in water at room temperature (FIG. 9E), (4) suspended in water at 4° C. (FIG. 9F), and (5) 15° C., 75% humidity (FIG. 9G). It is evident that the scale-up vitamin A-loaded EPO formulation MPs have the best performance in stabilizing the encapsulated vitamin A.

Switching the organic solvent from methylene chloride to acetone during the spinning disc atomization process did not cause any significant difference in particle formation and collection.

Switching to an alternative EPO batch from a different vendor, i.e., from Evonik EPO to Vikram EPO, did not cause any significant difference in formation and collection.

Powder containing 10% vitamin was successfully prepared with extrusion followed by milling as illustrated by FIG. 10. The average particle size of the powder was susceptible to the milling conditions such as milling temperature (e.g., room temperature milling or cryo milling) and milling method (e.g., Fitz milling or jet milling) The average particle size ranged from approximately 30 μm to approximately 500 μm in diameter. The power was susceptible to caking over time.

### Example 5

### Human Study 2—Bioavailability of Iron Particles of Higher Loadings in Humans

Materials and Methods

Detailed procedures for human study 2 is described in Example 3. The iron-loaded microparticles used in human study 2 are described in Example 4 and listed in Table 5.

TABLE 5
Process design formulation parameters and loadings for MPs used
in the second human study.
Human Study 2 MPs

| | Fe-HA MPs | | Fe-HA-EPO MPs | |
|---|---|---|---|---|
| | (Spray Dry) | | (Spinning Disc) | |
| Fe Isotope | FeSO₄ | HA | HA-Fe | EPO |
| (mg of Fe/g of MP) | Feed (g) | Feed (g) | Feed (g) | Feed (g) |
| ⁵⁴Fe | 5.57 | 9.84 | 9.23 | 19.44 |
| (31.9 ± 0.7 mg/g) | (1.98 g ⁵⁴Fe) | | | |
| ⁵⁷Fe | 3.78 | 1.89 | 3.57 | 0.32 |
| (182.9 ± 3.8 mg/g) | (1.41 g ⁵⁷Fe) | | | |
| ⁵⁷Fe | 0.80 | 2.35 | N/A | N/A |
| (87.5 ± 1.0 mg/g) | (0.30 g ⁵⁷Fe) | | | |

| | VitA-EPO MPs | |
|---|---|---|
| Vitamin A Isotope | (Spinning Disc Collected in Starch Bed) | |
| (mg/g of MP) | VitA Feed (g) | EPO Feed (g) |
| Vitamin A | 54 | 1026 |
| (34 ± 2.4 mg/g) | | |

Results

Fe HA-EPO MPs at over 5-fold and over 30-fold higher iron loading, i.e., 3.19% Fe-HA-EPO MPs and 18.29% Fe-HA-EPO MPs, respectively, compared to the lab-scale batch used in the first human trial, were investigated for their ability to deliver bioavailable iron to humans in a second human study.

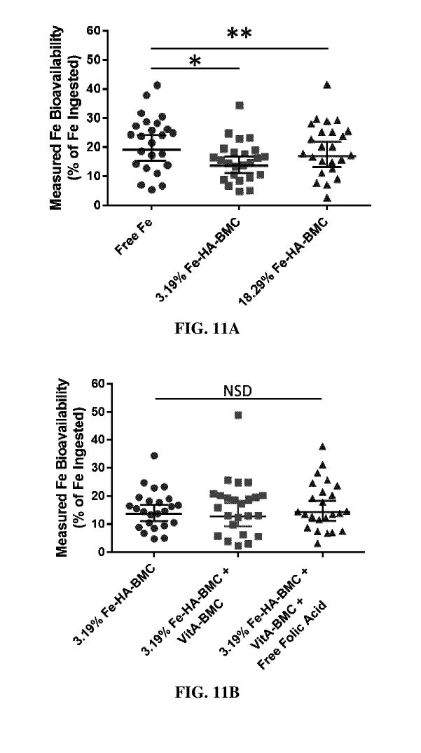

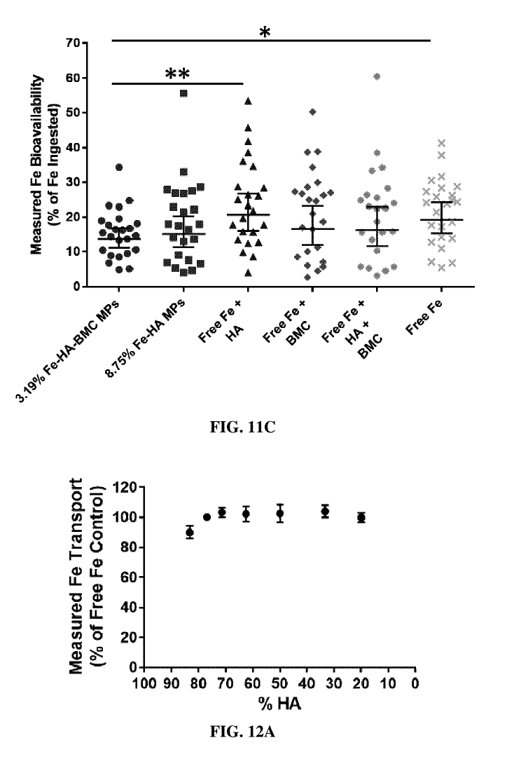

In this study, a non-iron inhibiting food matrix (wheat bread) was used to better compare unencapsulated iron and encapsulated iron by solely focusing on absorption, as opposed to both absorption and particle-mediated protection against small molecules that chelate or react with iron. In this study, 9 test meals, containing identical doses of iron (4 mg Fe) were administered in a partially randomized single-blind, cross-over design to fasting young women (n=24, Hb: 13.2±0.95 g/l, and PF: 13.2 (10.5, 16.5) μg/L) (Table 3). Three meals contained iron as labeled ferrous sulfate in 3.19% ⁵⁴Fe-HA-EPO MPs, 18.29% ⁵⁷Fe-HA-EPO MPs, and 4 mg unencapsulated ferrous sulfate (⁵⁸Fe, reference meal). In all cases, iron was added prior to baking the bread at 190° C. for 20 minutes. In contrast to the first human study, 18.29% Fe-HA-EPO-MPs (FIA: 17.0 (13.2, 21.9)%) exhibited iron absorption that was not statistically different relative to unencapsulated iron (FIA: 19.2 (15.3, 24.29)%) (FIG. 11A). The 5-fold higher loaded 3.19% Fe-HA-EPO MPs (FIA: 13.7 (11.1, 16.8)%) exhibited significant lower absorption as compared to both unencapsulated and the highest loaded 18.29% Fe-HA-EPO MPs. Compared to the reference meal, 3.19% and 18.29% Fe-HA-EPO MPs exhibited 71 (62, 82)% and 89 (74, 107)% relative iron bioavailability, respectively. In this same human study, how competitive absorption, related to the co-delivery of other micronutrients or EPO-encapsulated micronutrients alongside Fe-HA-EPO MPs, can influence absorption of iron from Fe-HA-EPO MPs was investigated. It was demonstrated that co-delivery of: (i) VitA-EPO MPs (FIA: 12.7 (9.29, 17.5)%), or (ii) VitA-EPO MPs with free folic acid (FIA: 14.3 (11.2, 18.3)%) did not impact iron absorption (FIG. 11B), indicating that competition between co-delivered micronutrients or EPO-encapsulated micronutrients is not a major concern for the combinations studied here. In 4 additional test meals the individual role of each MP component and how co-administering these components in free form influences absorption of iron as compared to formulation Fe-HA-EPO MPs were investigated. The results indicate that absorption from free ferrous sulfate is not significantly affected by either HA (FIA: 20.7 (16.1, 26.7)%), EPO (FIA: 16.6 (12.0, 23.2)%) or HA-EPO (FIA: 16.3 (11.7, 22.8)%). Similarly, when Fe is encapsulated in HA (FIA: 15.1 (11.3, 20.3)%) iron absorption is not significantly different from the reference meal (FIG. 11C). The results indicate that absorption is not significantly affected by either HA or EPO as compared to free iron; however, when HA and EPO are formulated as MPs, a decrease in absorption compared to free iron and free iron with the HA is observed (FIG. 11C). Importantly, this phenomena is unlikely to occur for the highest loaded 18.29% Fe-HA-EPO MPs formulation, as it demonstrated comparable absorption relative to the reference (FIG. 11C). Collectively, these results clearly indicate that the absorption limiting encapsulation that was observed in the first human study, can be overcome and addressed through development and increased loading of iron and decreased EPO content in HA-EPO MPs.

### Example 6

### Iron Transport in an In Vitro Intestinal Barrier Model

Materials and Methods

Epilntestinal tissues were purchased from MatTek (Ashland, Mass.) and used as recommended. For transport experiments, the particle constituents EPO, Fe, and HA were separately prepared and added to achieve final mass percentages as reported. After 1 hour of incubation at 37° C. and 5% CO2, transport iron was analyzed in the bottom transwell chamber using the previously described BioVision colorimetric assay.

Results

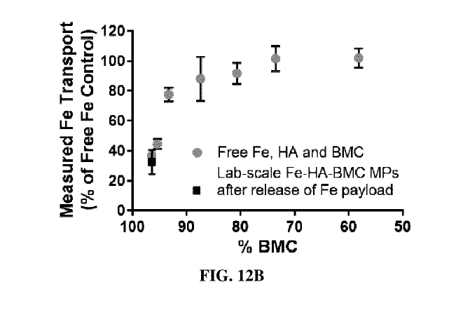

While the first human study showed that Fe encapsulation in HA-EPO MPs reduces iron bioavailability as compared to unencapsulated iron, the encapsulation system demonstrated efficacy in delivering bioavailable iron to humans, independent of cooking conditions. It has been previously reported that materials that encapsulate micronutrients can interfere with absorption (Zimmermann, Int J Vitam Nutr Res, 74, 453-461 (2004)). As such, the role that HA and EPO independently play in the intestinal absorption of iron was investigated. In vitro studies were designed to simulate conditions of iron penetration of the intestinal epithelial cell barrier in humans following oral ingestion of Fe-HA-EPO MPs. A commercially available human intestinal epithelial cell barrier model (Epilntestinal, MatTek, Ashland, Mass.) provided a test platform to investigate the effect the MP constituents have on intestinal iron absorption by systematically varying the relative concentrations of iron, HA, and EPO. The model consisted of primary small intestine epithelial cells obtained from a healthy human donor, wherein the cells were dissociated enzymatically and cultured in customized medium on cell culture inserts within 12-well-plates forming a functional, columnar-like 3D epithelial barrier layer (Maschmeyer, et al., Eur J Pharm Biopharm, 95, 77-87 (2015)). Oral administration of iron formulations was modeled by adding samples into the apical surface of the intestinal barrier, accessible as the cell culture insert in the upper compartment of the well-plate and, after a one-hour incubation period, quantifying iron transport as the amount that passed through the tissue barrier and could be determined by analysis of the culture medium in the lower compartment of the well-plate. The transport of iron added in combination with HA and/or EPO was expressed as a percentage of the transport of free iron added in the absence of HA or EPO. HA presence exhibited no significant impact on iron transport through the intestinal barrier (FIG. 12A). Moreover, iron was readily transported through the barrier at the Fe:HA ratio used in the MPs tested in this first human study. In contrast, unencapsulated EPO added to iron at increasing percentages significantly reduced iron transport through the intestinal barrier (FIG. 12B, circles). In particular, iron was poorly transported through the barrier when present at the EPO percentage of 96%, which corresponds to the percent EPO in the MPs tested in human subjects. At the percentage of EPO present in the current MP formulation, iron transport was reduced to 37% compared to free iron. Similarly, iron transport was reduced to 33% of that measured for free iron when the neutralized contents of MPs dissociated by incubation in SGF were added to the intestinal barrier (FIG. 12B, black square). Interestingly, as EPO percentage is decreased the iron transport-inhibiting effects of EPO becomes negligible, which indicates that formulations containing lower percentage of EPO may not inhibit iron transport across the intestines.

We claim:

1. Particles comprising an enteric polymeric barrier to moisture and air on the surface, the particles having co-encapsulated therein fat soluble and water soluble micronutrients within an inert matrix comprising starch or hyaluronic acid.

2. The particles of claim 1 formulated by emulsion of the fat soluble micronutrients in an organic solvent and emulsion of the water soluble micronutrients in an aqueous solvent.

3. The particles of claim 1 wherein the particles are formed by spray drying or spin disking.

4. The particles of claim 1 wherein the particles comprise iron micronutrients, and the enteric polymeric barrier prevents oxidation of the iron.

5. The particles of claim 1 wherein the micronutrients are mixed with hyaluronic acid prior to or at the time of encapsulation.

6. The particles of claim 1 wherein the particles are formed by spray drying or spin disking micronutrients, optionally in a solvent, into starch, hyaluronic acid, cyclodextrin, collagen, alginate, chitin, or derivatives thereof.

7. The particles of claim 1 comprising iron micronutrients.

8. The particles of claim 7 wherein the particles comprise ferrous sulfate mixed with hyaluronic acid in a ratio of iron:hyaluronic acid of between about 1:4 and about 1:10.

9. The particles of claim 1 wherein the fat soluble micronutrients are one or more vitamins selected from the group consisting of vitamin A, vitamin E, and vitamin D.

10. The particles of claim 1 wherein the water soluble micronutrients are selected from the group consisting of vitamin C, B3, B7, B9, and B12 and trace elements such as zinc and iodine.

11. The particles of claim 1 wherein the water soluble micronutrients are encapsulated in a first matrix formed by a hydrophilic or amphiphilic polymer such as hyaluronic acid or gelatin, then further coated or encapsulated by a second matrix formed by an enteric polymer.

12. The particles of claim 11 wherein the micronutrients are encapsulated using microencapsulation techniques such as spray drying or spinning disc atomization into a powder such as a starch powder which prevents agglomeration and deformation of the particles.

13. The particles of claim 1 wherein the formulation is stable up to one hour at 100° C. or at 75% humidity 40° C. for at least sixty days.

14. The particles of claim 1 having a diameter between one micron and one millimeter, preferably about 150 microns.

15. The particles of claim 1, wherein the pH-sensitive polymer dissolves at a pH from about 1-5, preferably from about 1-3, more preferably from about 1-2.

16. The particles of claim 1, wherein the pH-sensitive polymer dissolves at a pH from about 5-8, preferably from about 5-7, more preferably from about 5-6.

17. The particles of claim 1, wherein the pH-sensitive polymer is a polymethacrylate.

18. A method of providing iron and/or other micronutrients, comprising providing an effective amount of the formulation of claim 1 to an individual in need thereof.

19. The method of claim 18, wherein the formulation, optionally mixed with or coated with salt, is mixed with food.

20. The method of claim 18, wherein the formulation is provided in bulk form to agricultural animals.

21. A method for making the particles of claim 1 comprising
providing particles of an iron supplement mixed with an antioxidant polymer such as hyaluronic acid and/or one or more fat soluble vitamin,
dispersing the iron mixture or vitamin in a pH-sensitive enteric polymer,
Forming particles by spray drying or spin disking, and
Wherein the particles are sprayed into starch or other non-agglomerating polymeric powder to form a powder coating when the particles contain fat soluble vitamins.

22. A method of co-encapsulating water-soluble micronutrients and fat-soluble micronutrients into an enteric polymer barrier coated particle of claim 1 comprising
dissolving and/or dispersing the water-soluble micronutrients into an aqueous solvent to form a water-soluble micronutrient solution, optionally comprising starch, hyaluronic acid, cyclodextrin, collagen, alginate, chitin, or derivatives thereof;
adding oil at the time of or after dissolving or dispersing the micronutrients into the aqueous solvent;
dissolving and/or dispersing the fat-soluble micronutrients into an organic solvent and/or oil and enteric polymer to form a fat-soluble micronutrient polymer solution;
emulsifying the water-soluble micronutrient solution with the fat-soluble micronutrient polymer; and
removing the solvent using a method such as spray drying, spin disking or solvent removal.
